(19) United States
(12) Patent Application Publication
(10) Pub. No.: US 2023/0376903 A1
(43) Pub. Date: Nov. 23, 2023

(54) AUTOMATIC PROJECT PLANNING, BUDGETING, AND TRACKING TOOL

(71) Applicant: Providence St. Joseph Health, Seattle, WA (US)

(72) Inventors: Jennifer Dumont, Portland, OR (US); Bert Martin, Vancouver, WA (US); Terri Trobridge, Trabuco Canyon, CA (US)

(21) Appl. No.: 17/746,820

(22) Filed: May 17, 2022

(51) Int. Cl. G06Q 10/10; G06Q 10/06

(52) U.S. Cl. CPC G06Q 10/103; G06Q 10/06316; G06Q 10/063118

(57) ABSTRACT

A facility for tracking a planned project is described. The facility initializes a project-tracking data object, and responds to user input by assembling in the data object a hierarchical model of the project, from project elements each having one of a plurality of element types. The facility persistently stores the data object containing the assembled model.

### BACKGROUND

It is common for teams of people to work together on project after project that are similar. For example, a healthcare organization whose management brings additional medical practices into the organization may operate a number of projects for each one, such as investigating the application and hardware used by the practitioners; investigating the financial systems of the practice; connecting members of the practice to information technology (“IT”) systems used in the healthcare organization, and transitioning staff to become part of the larger healthcare organization; etc.

### BRIEF DESCRIPTION OF THE DRAWINGS

FIG. 1 is a block diagram showing some of the components typically incorporated in at least some of the computer systems and other devices on which the facility operates.

FIG. 2 is a flow diagram showing a process performed by the facility in some embodiments to create project elements for use in assembling a project.

FIG. 3 is a project diagram showing phases and activities of a sample project.

FIG. 4 is a display diagram showing sample contents of an administration tools display presented in some embodiments.

FIG. 5 is a display diagram showing sample contents of a display presented by the facility in some embodiments for the phases tool when the phases icon is activated.

FIG. 6 is a display diagram showing sample contents of a display presented by the facility in order to add an activity.

FIG. 7 is a display diagram showing sample contents of a display presented by the facility in some embodiments to add key events to the facility's project element inventory.

FIG. 8 is a display diagram showing sample contents of a key event schedule grid display presented by the facility in some embodiments.

FIG. 9 is a display diagram showing sample contents of an add checklist items display presented by the facility in some embodiments in order to add checklist items to the facility's inventory.

FIG. 10 is a display diagram showing sample contents of a new cost model display presented by the facility in some embodiments in order to enter a new cost model used by the facility to budget for projects.

FIG. 11 is a display diagram showing sample contents of a second add cost model display presented by the facility in some embodiments.

FIG. 12 is a flow diagram showing a process performed by the facility in some embodiments in order to create and operate a project, also called an “initiative.”

FIG. 13 is a display diagram showing sample contents of a display for creating a new project prepared by the facility in some embodiments.

FIG. 14 is a display diagram showing sample content of a display presented by the facility in some embodiments to permit a user to select among created projects.

FIG. 15 is a display diagram showing sample contents of a display diagram containing information about sample project Mesozoic prepared by the facility in some embodiments.

FIG. 16 is a display diagram showing sample contents of a display presented by the facility in some embodiments to present key data associated with sample project Mesozoic.

FIG. 17 is a display diagram showing sample contents of a display presented by the facility in some embodiments to present and receive information about roles assigned in a project.

FIG. 18 is a display diagram presented by the facility in some embodiments in order to add an activity to a project.

FIG. 19 is a display diagram showing sample contents of a display presented by the facility in some embodiments to continue adding an activity to a project.

FIG. 20 is a display diagram showing sample contents of a display presented by the facility in some embodiments to continue adding an activity.

FIG. 21 is a display diagram showing sample contents of a display presented by the facility in some embodiments to continue adding activities to a sample project.

FIG. 22 is a display diagram showing sample contents of a display presented by the facility in some embodiments to continue adding activities to a sample project.

FIG. 23 is a display diagram showing sample contents of a display presented by the facility in some embodiments to update checklist items.

FIG. 24 is a display diagram showing sample contents of a display presented by the facility in some embodiments to continue adding a start date to an activity.

FIG. 25 is a display diagram showing sample contents of a display presented by the facility in some embodiments to display dates automatically added to the selected activity's key events.

FIG. 26 is a display diagram showing sample contents of a display presented by the facility in some embodiments to present a schedule grid for key events of an initiative.

FIG. 27 is a display diagram showing sample contents of a display presented by the facility in some embodiments to view and update checklist items for an initiative.

FIG. 28 is a display diagram showing sample contents of a display presented by the facility in some embodiments to estimate schedule and cost information for a project.

FIG. 29 is a spreadsheet diagram showing sample contents of a spreadsheet exported by the facility in some embodiments to provide information about key events.

FIG. 30 is a display diagram showing sample contents of a key event report display presented by the facility in some embodiments.

FIG. 31 is a display diagram showing sample contents of the key event report in a second view.

FIG. 32 is a display diagram showing sample contents of a cost model report display presented by the facility in some embodiments.

FIG. 33 is a display diagram showing sample contents of the cost model report presented by the facility in some embodiments in a second state.

FIG. 34 is a display diagram showing sample contents of a display presented by the facility in some embodiments to provide project analytics.

FIG. 35 is a display diagram showing sample contents of a project status dashboard presented by the facility in some embodiments.

### DETAILED DESCRIPTION

The inventors have identified significant disadvantages of the conventional approaches commonly used to plan, operate, and evaluate multi-participant projects such as those listed above. It is typical for projects to be planned and documented using plan documents numbering the tens or hundreds of pages, each either manually-created for the project, or copied from an earlier project manually selected as similar. These plans are time-consuming and expensive to produce.

The inventors have also recognized that this large set of project documentation tends to be difficult to use, making it infrequently reviewed; seldom updated to reflect changes to the project or its evolving status; and little-consulted after the conclusion of the project to inform future projects.

In response to recognizing these limitations and disadvantages, the inventors have conceived and reduced to practice a software and/or hardware facility for automatic project planning, budgeting, and tracking (“the facility”). In various embodiments, the facility supports the definition of project elements; assembling elements into projects; maintaining and reviewing the status of a project; adapting the project while in process; and analyzing the outcome of a project.

The facility provides a user interface mechanism for defining project elements for use in designing projects. In some embodiments, these can include elements of the following types: project phases, each corresponding to a different high-level portion of the project; activities, each corresponding to a task to be performed in a particular phase; key events, each corresponding to a milestone established within a particular activity; and checklist items, each specifying a way in which activity results are verified for a particular key event.

The facility further provides a user interface mechanism for assembling project elements into projects. For example, a user may establish phases such as the following for a sample project relating to connecting members of a medical practice to the IT systems used in a healthcare organization: an intake phase, a due diligence phase, a preliminary planning phase, and an execution phase. The due diligence phase may include a due diligence activity, which in turn contains key events such as an IS due diligence kickoff, which in turn contains checklist items such as verifying IS stakeholders and creating a presentation deck on initiative care details.

In some embodiments, when a project is created, a user inputs attributes of the project, such as identifying information for the project and its project type; the identity of sponsors of the project; key data such as the number of users of different types in the medical practice to be incorporated; and participants and their roles. As a user adds project elements to a project, the user “parameterizes” them by adding data for the project that relates to the element. In some embodiments, this parameterization is automatic, based on attributes inputted for the project. As one example, in some embodiments, the facility automatically determines the budget and schedule for an install caregiver workstations task based on a number of caregivers project attribute. In some embodiments, the facility responds to the creation of a project by automatically determining, storing, and presenting aspects of the project such as project elements schedules and budgets.

The facility further provides a user interface mechanism for maintaining and reviewing the status of a project. For example, in some embodiments this user interface mechanism can be used to traverse the element hierarchy of a project; insert completion dates for elements; revise components of schedules and budgets; etc.

The facility further provides a user interface mechanism for analyzing the outcome of a project. In various embodiments, this mechanism exposes project details such as degree of project completion, actual completion date versus schedule by element, actual cost versus budget by element, etc.

In some embodiments, the facility enables a user to create a new project by “templating” a similar prior project and adapting it to the details of the present project.

By performing in some or all of these ways, the facility makes it much more straightforward to develop a project plan; use it as a basis for performing the project; maintain its currency, and thus the currency of target dates and pecuniary budgets; and analyze the project and its results.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks.

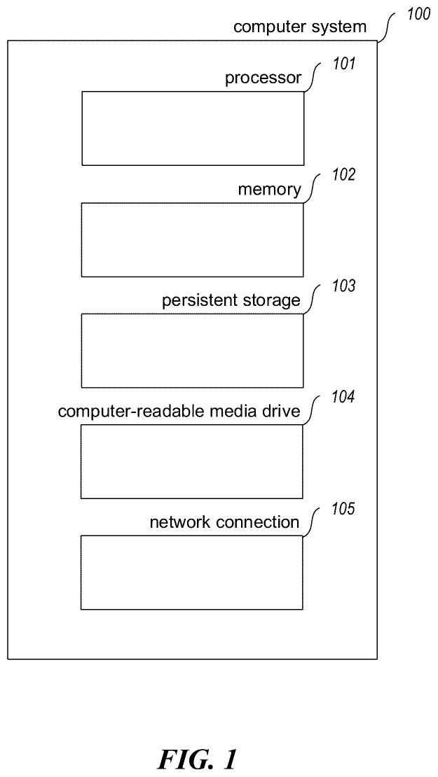

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

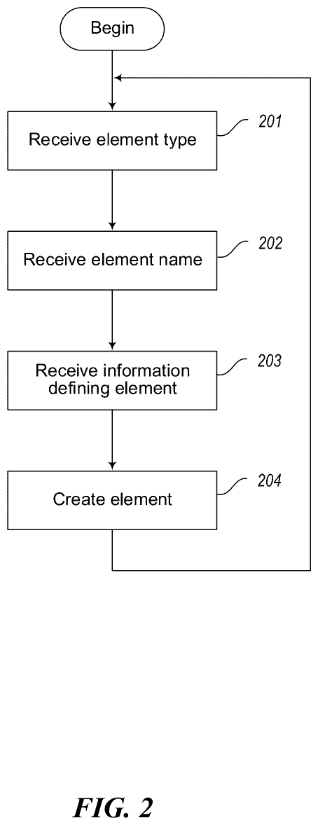

FIG. 2 is a flow diagram showing a process performed by the facility in some embodiments to create project elements for use in assembling a project. In act 201, the facility receives user input specifying an element type. In some embodiments, the available element types include project container, project phase, project activity, project key event, and project checklist item. In various embodiments, the facility supports a wide variety of element types. In act 202, the facility receives a name for a new element of the element type received in act 201. As one example, the facility may receive in act 202 the element name “install caregiver workstations” for a received element type of activity. In act 203, the facility receives information defining the element. To extend the example, the facility may receive information defining a “number of caregivers” attribute that the installed caregiver workstations activity will use as a basis for projecting the pecuniary cost and amount of time needed to perform the activity. In act 204, the facility creates a new project element containing the information received at 201-203. In some embodiments, the facility adds the element created in act 204 to an inventory of elements available to a user in assembling a new project. After act 204, the facility continues in act 201 to receive the next element type.

Those skilled in the art will appreciate that the acts shown in FIG. 2 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

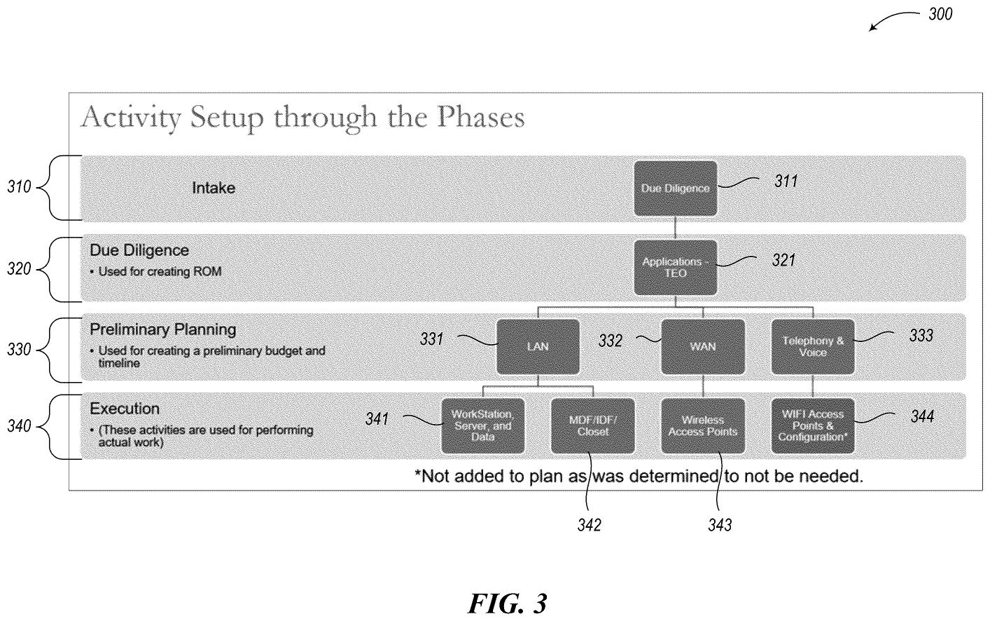

FIG. 3 is a project diagram showing phases and activities of a sample project. The diagram 300 shows a progression of phases 310, 320, 330, and 340, each containing one or more activities. For example, phase 310 contains activity 311; phase 320 includes activity 321; phase 330 includes activities 331-333; and phase 340 contains activities 341-344. In particular, as the project (or “initiative”) moves through planning phases, the activities become more detailed, and can change based on new information that is gathered. For example, in the due diligence phase 320, the only activity is network applications—TEO activity 321; in the later phase of preliminary planning 330, this has been broken out to LAN, WAN, and telephony and voice activities 331-333. In the execution phase 340, the final blocks of work were determined and are identified as “actual” rather than “planning period.” Certain activities found not to be needed for the sample project are not included, including closet build, VPN setup, and Wi-Fi access points. In some embodiments, each activity can have a cost model that determines the cost to complete that activity, including such cost components as labor and materials. The model uses information about the project to determine the cost, for example, based on the number of employees or the square footage of the building that is the subject of the project. In some embodiments, the model in earlier phases is at a higher level, whereas the model for actual activities in many cases is much more detailed. In some embodiments, key events include models that predict duration, which also may be at a higher level in earlier phases and in more detailed level in later phases. The duration models, too, can use the size of the initiative or other attributes of the project or certain project elements to determine the duration of each event.

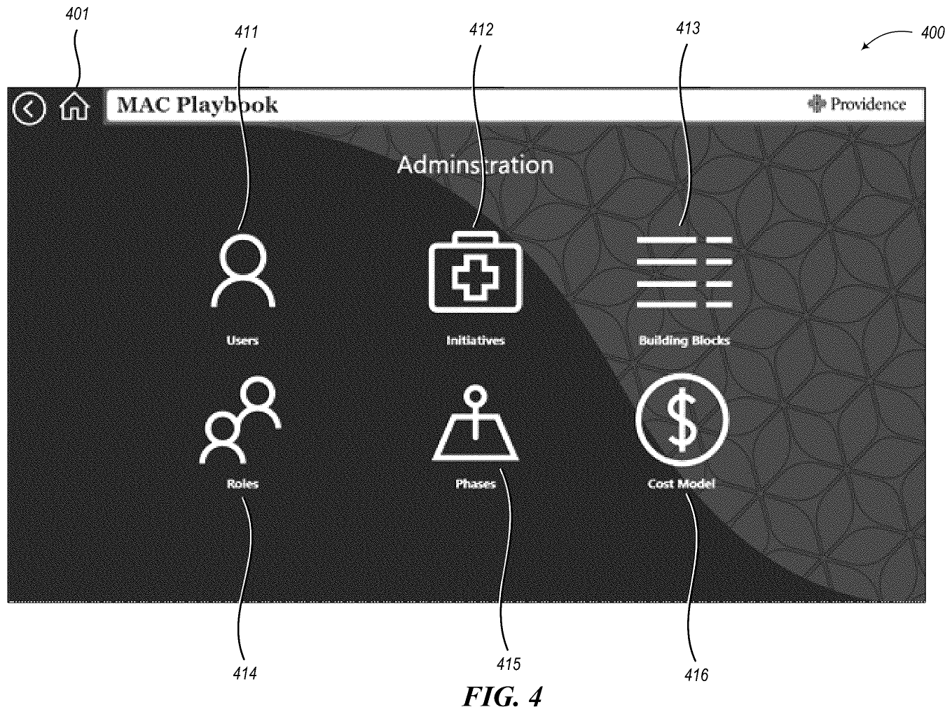

FIG. 4 is a display diagram showing sample contents of an administration tools display presented in some embodiments. The display 400 includes a home icon 401 that can be activated to return to a home display; a users icon 411 that can be activated to access a users tool, an initiatives icon 412 that can be activated in order to access an initiatives tool; a building blocks icon 413 that can be activated to access a building blocks tool; a roles icon 414 that can be activated to access a roles tool; a phases icon 415 that can be activated to access a phases tool; and a cost model icon 416 that can be activated to access a cost models tool.

While FIG. 4 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

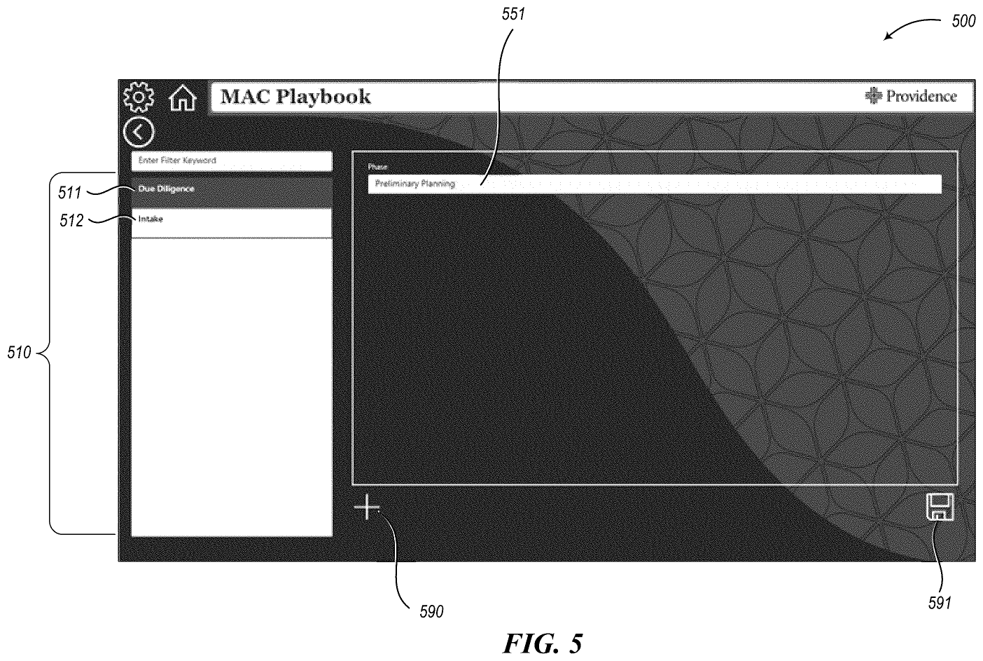

FIG. 5 is a display diagram showing sample contents of a display presented by the facility in some embodiments for the phases tool when the phases icon is activated. The display 500 for the phases tool enables a user to add a new phase as follows. In order to add a new phase to phases 511-512 already in the phase inventory 510, the user activates the add phase icon 590, enters the new phase's name in field 551, then activates the save icon 591.

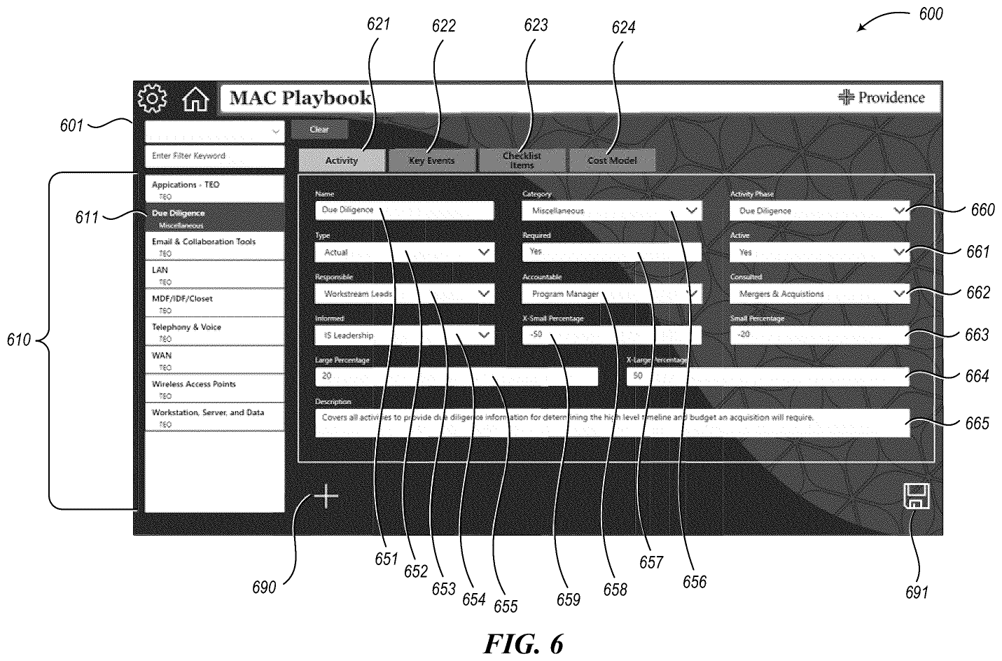

In some embodiments, in order to add an activity, the user activates the building blocks icon, and selects an activity tab. FIG. 6 is a display diagram showing sample contents of a display presented by the facility in order to add an activity. After clicking the activity tab 621, in order to add the new activity to the list of activities 610 included in the facility's activity inventory, the user can click the add activity icon 690, then enter information in fields 651-665 and actuate the save icon 691. The information that can be entered into these fields includes activity name 651; activity category 656, such as a team that is responsible for this activity; an activity phase 660 to which the activity belongs; an activity type 652, such as actual activity used to track actual work or plan the activity used to plan the budget and schedule; whether the activity is required 657 and automatically added to each project; whether the activity is active 661 and available to be added to new projects; the people assigned to responsible, accountable, consulted, and informed roles 653, 658, 662, and 654, respectively, for the project; extra-small, small, large, and extra-large percentages 659, 663, 655, and 654, respectively, used to calculate schedule and budget based upon the size of the initiative—in some embodiments, these values reflect the percentage relative to a medium-sized initiative—for this activity and each key event assigned to it; and description 665 describing the activity.

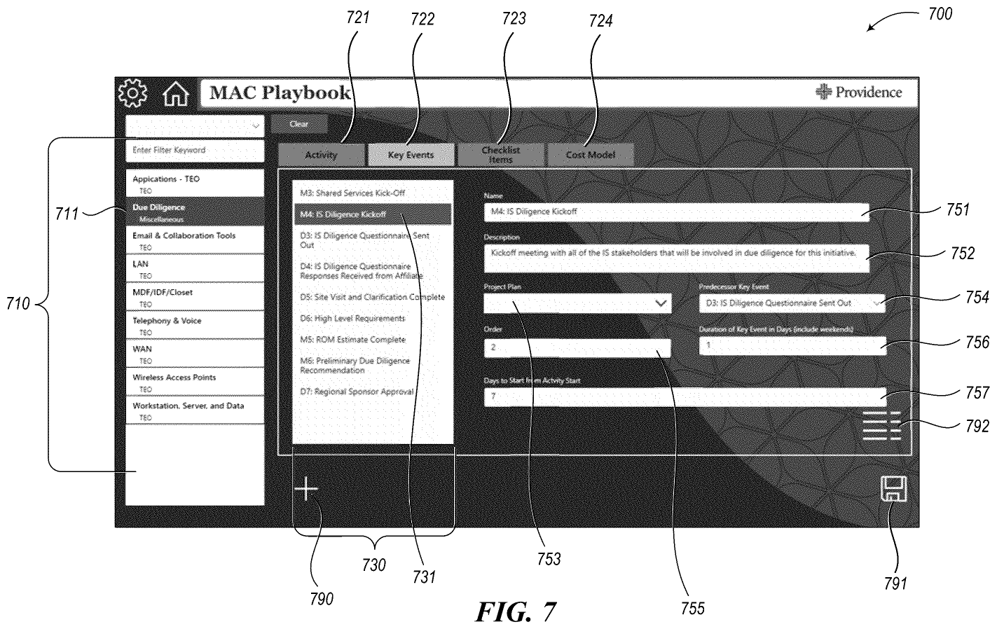

FIG. 7 is a display diagram showing sample contents of a display presented by the facility in some embodiments to add key events to the facility's project element inventory. In particular, the display 700 shows a list 710 of activities in the facility's project element inventory, of which the user has selected activity 711. In response, the facility has displayed list 730 of the key events in the facility's project element inventory that belong to the selected activity. After selecting the key events tab 722 among tabs 721-724, the user adds a new key event 731 to the facility's inventory of key event project elements 730 by first activating a new key event icon 790. After doing so, the user enters information about the key event in the following fields: a field 751 for the name of the key event; a field 752 for a description of the key event; a field 753 for the project plan that this key event will be part of; a field 754 for a key event that precedes the key event being created in the order of key events; a field 755 for an integer representing the order of this key event among the key events for the same activity; a field 756 for the duration in days of the key event for an initiative that is medium-sized; a field 757 in which to enter the number of days after the activity starts that the key event will begin for an initiative that is medium-sized. The user further selects, from a list 730 of activities, the activity to which the key event belongs. After entering this information, the user selects the save icon 791 in order to save the new event. In some embodiments, the user activates a grid icon in order to see the existing key events for the activity 711 selected among the list of activities 710.

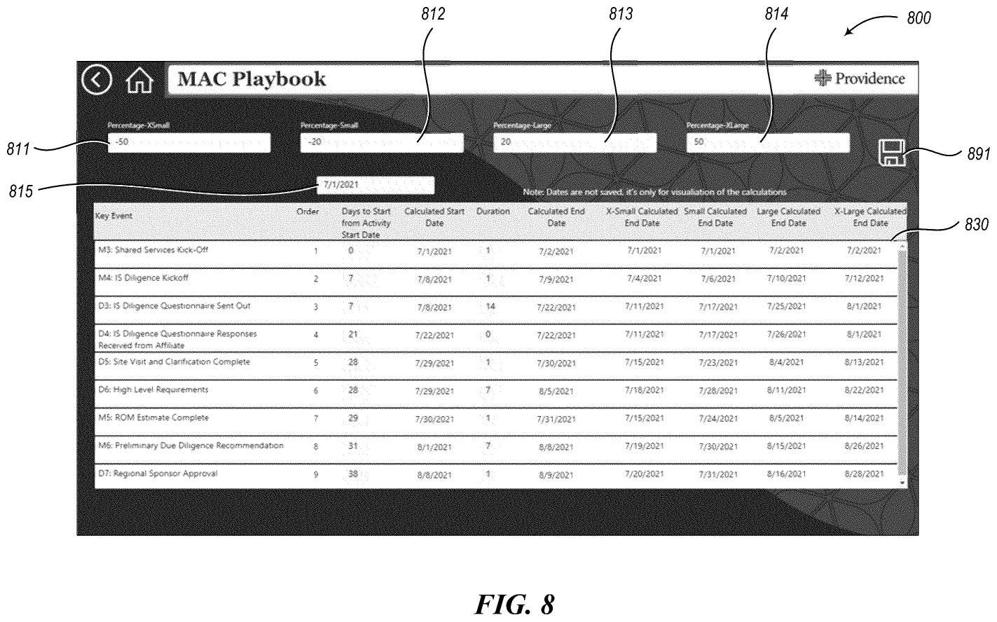

FIG. 8 is a display diagram showing sample contents of a key event schedule grid display presented by the facility in some embodiments. The diagram 800 includes the grid 830 in which each row is a different key event for the selected activity, showing that key event's name, order among the key events for the activity, and sample calculated dates. The display also shows fields 811-815, which contain values used to generate the calculated dates, and are editable by the user: field 811 shows the scaling factor used to determine the duration of key events for extra-small projects: they are 50% as long as the duration for medium projects; field 812 shows the scaling factor for small projects: their key event duration is 80% as long as the duration of key events for medium projects; field 813 shows the scaling factor for large projects: their key events are 120% as long as the duration of key events in a medium project; field 814 shows the scaling factor for extra-large projects: their key events have a duration that is 150% as long as key events in a medium project; and field 815 shows the starting date for the activity containing the shown key events. In addition to changing the values in fields 811-815, the user can, in some embodiments, change values in grid, such as values in the order, days to start from activity start date, and/or duration columns. Where the user makes a change in this display, the user can activate save icon 891 in order to save these changes.

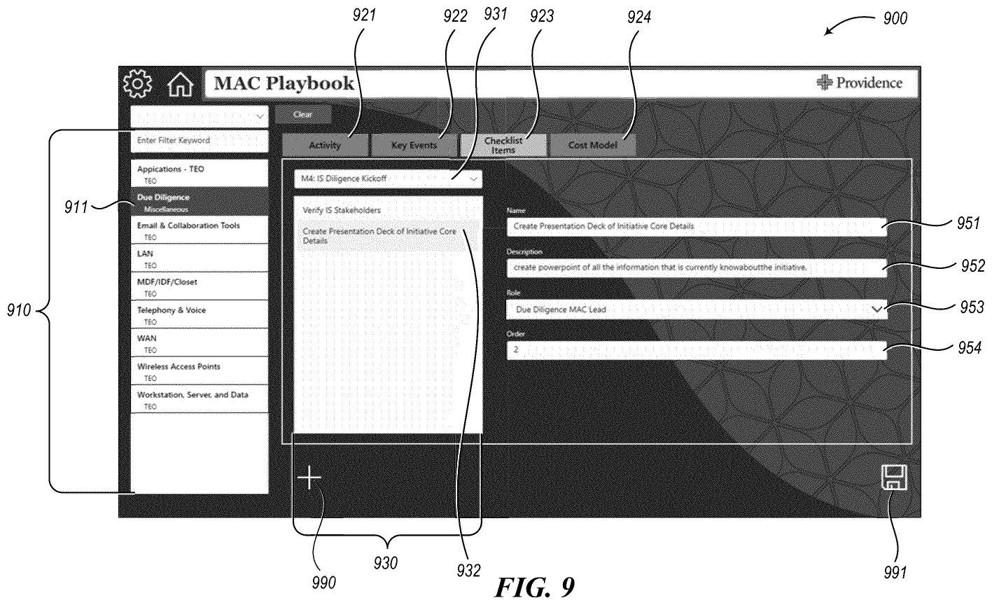

FIG. 9 is a display diagram showing sample contents of an add checklist items display presented by the facility in some embodiments in order to add checklist items to the facility's inventory. The display 900 shows that the user first selects the checklist items tab 923 among tabs 921-924. The user then selects the activity 911 among the facility's activity inventory that will contain the checklist item. The facility then uses control 931 to select the key event that will contain then new checklist item, which will be added to the inventory 930 of checklist items for the selected key event. The user then activates the new checklist item icon 990, and populates fields 951 and 954 as follows: field 951 for the name of the new checklist item; field 952 for a description of the new checklist item; field 953 for the role of the person who will complete the checklist item; and field 954 for the order of the checklist item among the checklist items for the selected key event. After doing so, the user activates save icon 991 to save the new checklist item in the facility's inventory of checklist items.

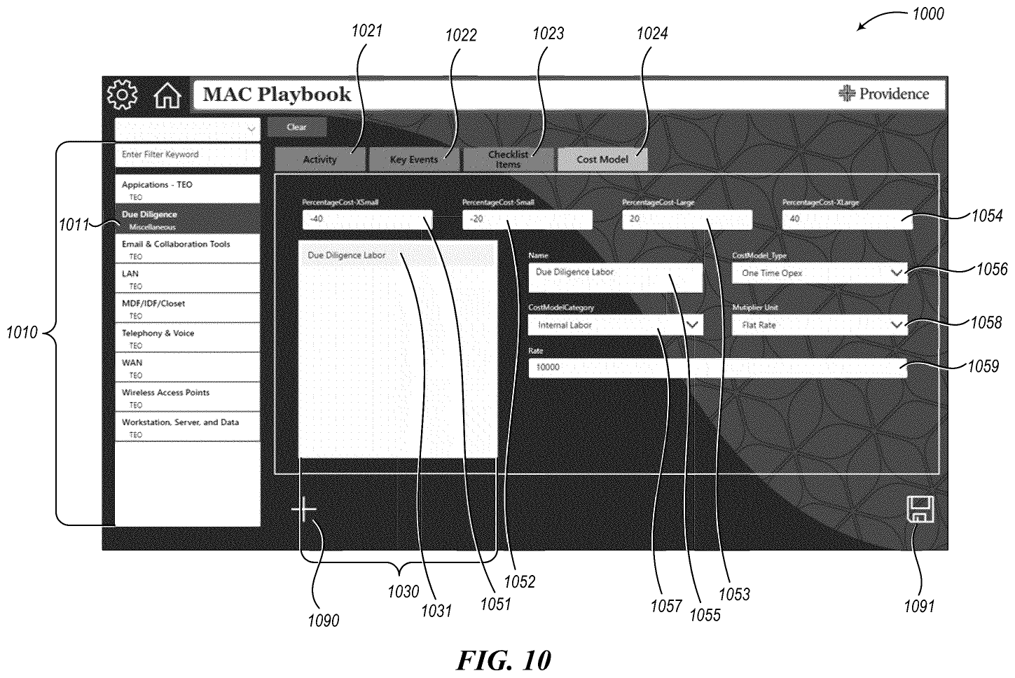

FIG. 10 is a display diagram showing sample contents of a new cost model display presented by the facility in order to enter a new cost model used by the facility to budget for projects. The display 1000 shows that the user selects cost model tab 1024 from among tabs 1021-1024. The user further selects activity 1011 to which the new cost model will apply from among the facility's inventory of activities 1010, and populates a number of fields that define the cost model: a name field 1055; a field 1056 specifying whether this cost is a capital expense or an operational expense; a field 1057 for specifying a category for the cost model; a field 1058 for specifying whether the cost is a flat cost, or is calculated on the basis of some project or project element attribute; and a rate field 1059 for specifying the cost for the cost model, for a project of medium size. The user also populates scaling fields 1051-1054 that each specify a scaling factor for converting a cost or duration determined for a medium project to the cost or duration that will be determined for projects of other sizes. After inputting this information, the user activates save icon 1091 in order to create the new cost model.

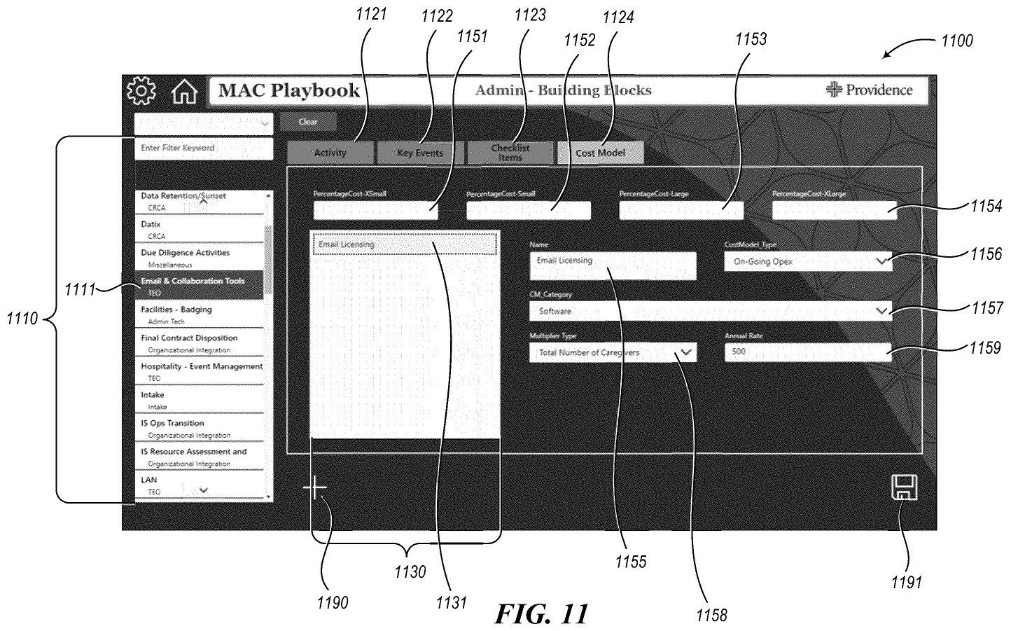

FIG. 11 is a display diagram showing sample contents of a second add cost model display presented by the facility in some embodiments. While this display 1100 is generally similar to display 1000 shown in FIG. 10, it can be seen that, in fields 1158 and 1159, the user has specified that the total cost for this “email licensing” cost model will be calculated by multiplying a total number of caregivers specified as an attribute for the project by the rate of $500. Also, scaling fields 1151-1154 are empty, as no conversion based upon project size is needed.

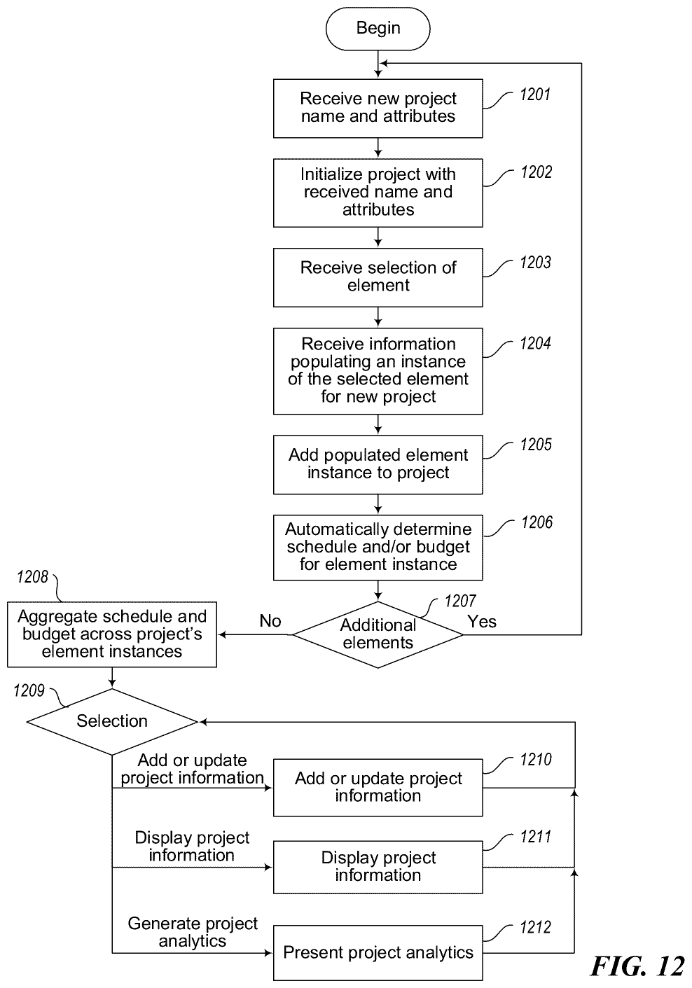

FIG. 12 is a flow diagram showing a process performed by the facility in some embodiments in order to create and operate a project, also called an “initiative.” In act 1201, the facility receives a name for a new project, and attributes for that project, such as number of caregivers involved, number of square feet, which information technology systems are already present and/or planned, etc. In act 1202, the facility initializes a new project with the name and attributes received in act 1201. In act 1203, the facility receives from a user selection of an element to add to the new project from the facility's element inventory. In act 1204, the facility receives from a user information populating an instance of the element selected in act 1203 for the new project. This can include, for example, attributes of the element instance, scheduling information for the element instance, etc. In act 1205, the facility adds the element instance as populated in act 1204 to the project. In act 1206, the facility automatically determines scheduled and/or budget information for the element instance added to the project. In act 1207, if additional elements remain to be added to the project, then the facility continues in act 1201 to add the next project element, else the facility continues in act 1208. In act 1208, the facility aggregates schedule and budget across the element instances added to the project. In act 1209, the facility branches on a selection made by the user: where the selection is to add or update project information, the facility continues in act 1210; where the selection is to display project information, the facility continues in act 1211; and where the selection is to generate project analytics, the facility continues in act 1212. In act 1210, the facility adds or updates project information, such as adding or removing an element; adding or revising completion dates and/or actual costs for particular project element instances; shifting the schedule or projected cost for certain element instances; etc. After act 1210, the facility continues in act 1209 to receive and act on the next selection. In some embodiments (not shown), after act 1210, the facility continues in act 1208 to recalculate budget and/or schedule of dependent elements, or the project as a whole. In act 1211, the facility displays project information. In some embodiments, in this act, the facility responds to the user navigating among the elements instances of the project, such as in a hierarchical traversal of the project's hierarchy. After act 1211, the facility continues back to 1209 to receive and act on the next selection. In act 1212, the facility presents analytics for the project. After act 1212, the facility continues in act 1209 to receive and act on the next selection.

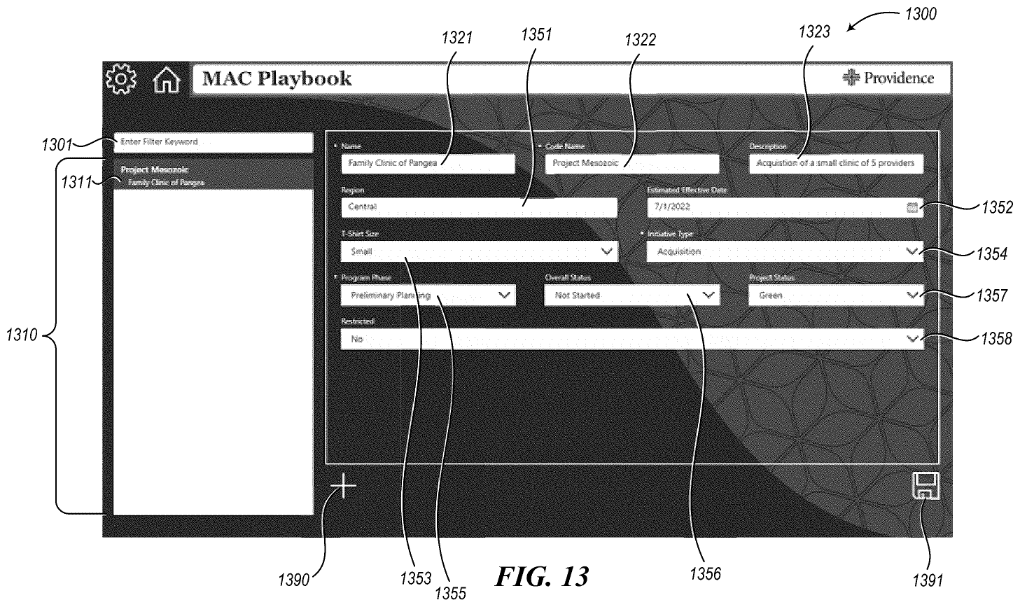

FIGS. 13-36 illustrate the facility's performance of the process shown in FIG. 12.

FIG. 13 is a display diagram showing sample contents of a display for creating a new project prepared by the facility in some embodiments. In some embodiments, the facility presents display 1300 in response to the user's selection of the initiatives icon 412 shown in display 400 appearing in FIG. 4. In order to add a new project 1311 to the facility's list of projects 1310, the user activates an add project icon 1390. The user then populates some or all of fields 1321-1323 and 1351-1358 with attributes values for the project, as follows: field 1321 for the name of the initiative; field 1322 for a code name to be used for a confidential initiative; a field 1323 for a description of the initiative; a field 1351 for a geographic region with which the initiative is associated; a field 1352 for specifying the estimated date that the initiative will begin; field 1353 specifying the size of the initiative, which is used by the facility to scale project element durations and costs for the project relative to projects of medium size; a field 1354 for the initiative's type; a field 1355 for specifying the current phase of the initiative; field 1356 for specifying the initiative's status, such as not started, in progress, completed, or canceled; a field 1357 for indicating how well the project is going, such as green, yellow, or red; and a field 1358 for specifying whether special access rights are needed to access this initiative. After entering this information, the user activates a save icon 1391 to create the initiative, populating it 1311 into initiative list 1310.

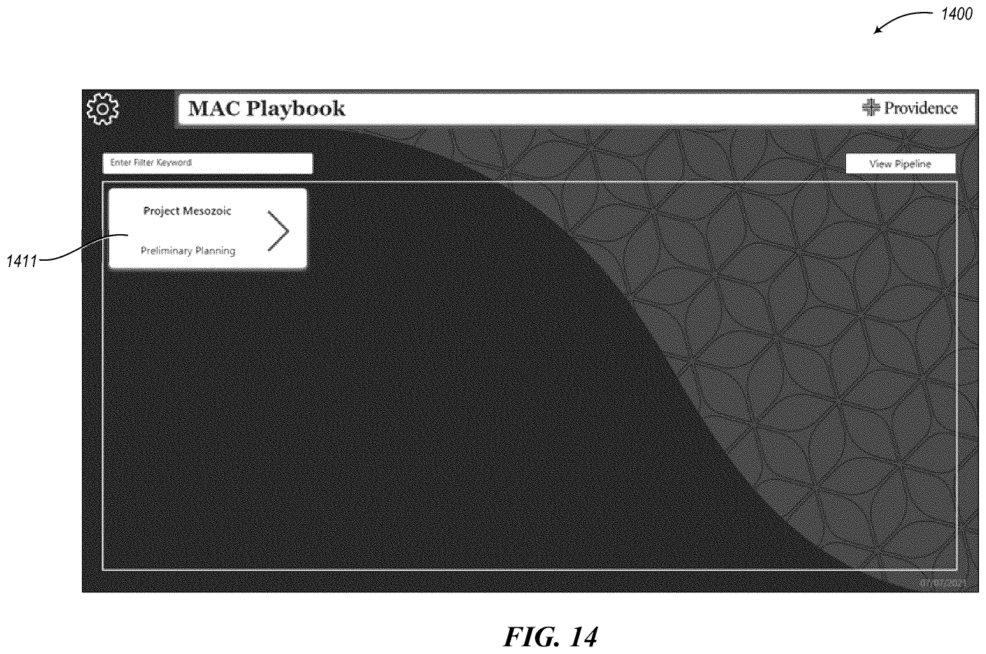

FIG. 14 is a display diagram showing sample content of a display presented by the facility in some embodiments to permit a user to select among created projects. The display 1400 includes a set of rectangles each corresponding to one of the projects in the facility's project list; in this case, only a single project rectangle 1411, for project Mesozoic, is shown. In some embodiments, the user can activate a project rectangle in order to display and enter information about that project.

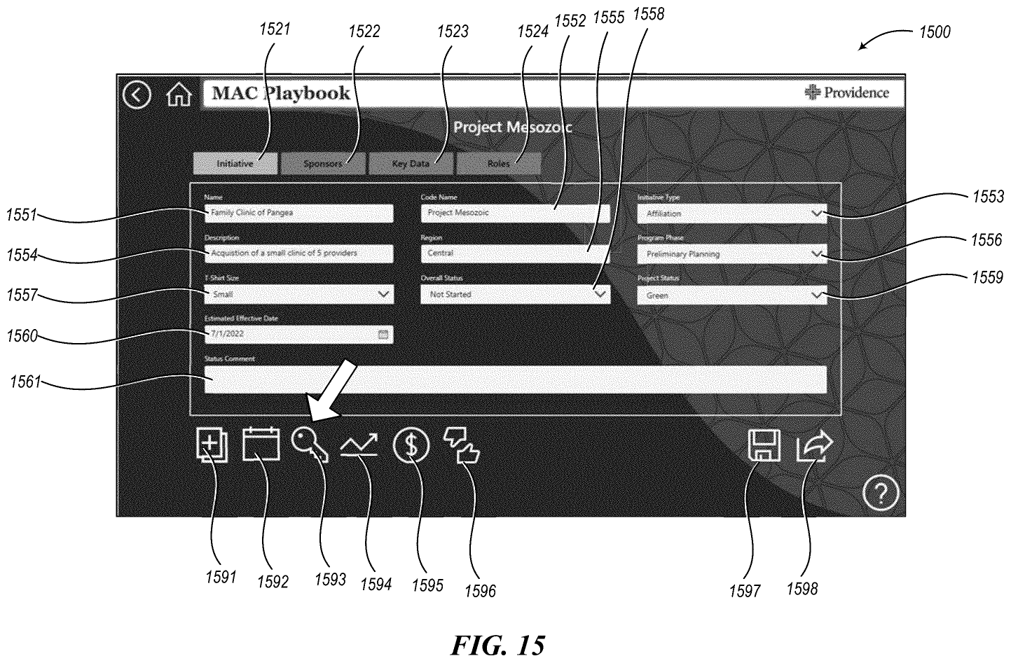

FIG. 15 is a display diagram showing sample contents of a display diagram containing information about sample project Mesozoic. The display 1500 includes tabs 1521-1524 for selecting different views on project Mesozoic data; initiative tab 1521 is selected. Fields 1551-1561 show project attribute data that the user can review, and change or add if needed. The display also includes action icons 1591-1598. In order to navigate to another view of project Mesozoic data, the user can click one of the other tabs 1521-1524, such as tab 1523 for key data.

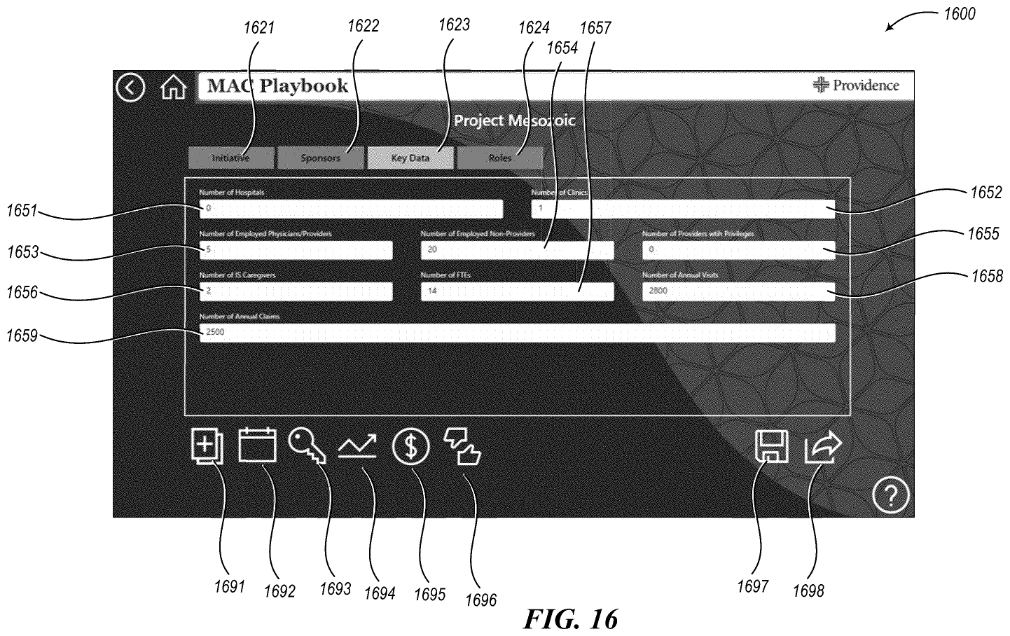

FIG. 16 is a display diagram showing sample contents of a display presented by the facility in some embodiments to present key data associated with sample project Mesozoic. The display 1600 includes tabs 1621-1624 for navigating among the views; key data tab 1623 is selected. The display further includes fields 1651-1660 for entering, viewing, or changing key data attributes for the project, as follows: field 1651 for the number of hospitals to which the project relates; field 1652 for the number of clinics to which the project relates; field 1653 for the number of physician providers to which the project relates; field 1654 for the number of non-provider employees to which the project relates; field 1655 for the number of providers with privileges to which the project relates; field 1656 for the number of information technology employees involved in the project; field 1657 for the number of full time employees to which the project relates; field 1658 for the number of patient visits annually to which the project relates; and field 1659 for the number of insurance claims annually to which the project relates. After inputting information in these fields, the user activates save icon 1697 to save it for the project.

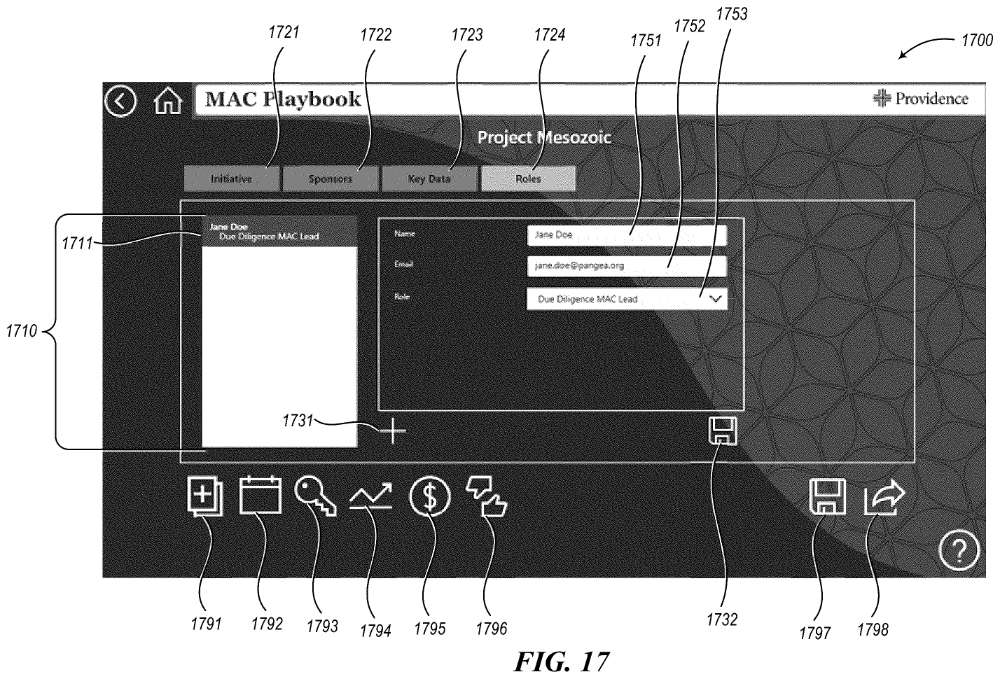

FIG. 17 is a display diagram showing sample contents of a display presented by the facility in some embodiments to present and receive information about roles assigned in a project. The display 1700 shows that, among tabs 1721-1724, roles tab 1724 is selected. In order to add a person in a role 1711 to the list 1710 of roles for the project, the user activates the tab role icon 1731, then populates fields 1751-1753, field 1751 for the person's name; field 1752 for the person's email address; and control 1753 for selecting the person's role for the project, in this case the “Due Diligence MAC Lead.” The user then activates save icon 1732 in order to add this person in the due diligence MAC lead role to list 1710 of project roles.

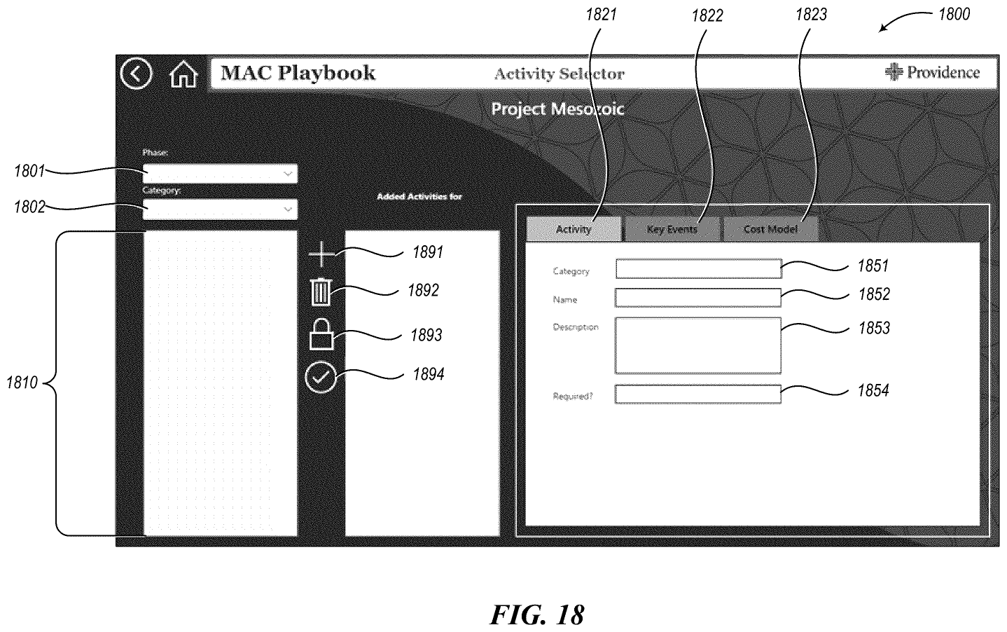

FIG. 18 is a display diagram presented by the facility in some embodiments in order to add an activity to a project. In some embodiments, the facility presents display 1800 in response to the user activating add icon 1791, such as in display 1700 shown in FIG. 17. The display includes a phase control 1801, in which the user selects a phase to which the user wishes to add an activity. For example, the user can use control 1801 to select a “due diligence” phase of the project.

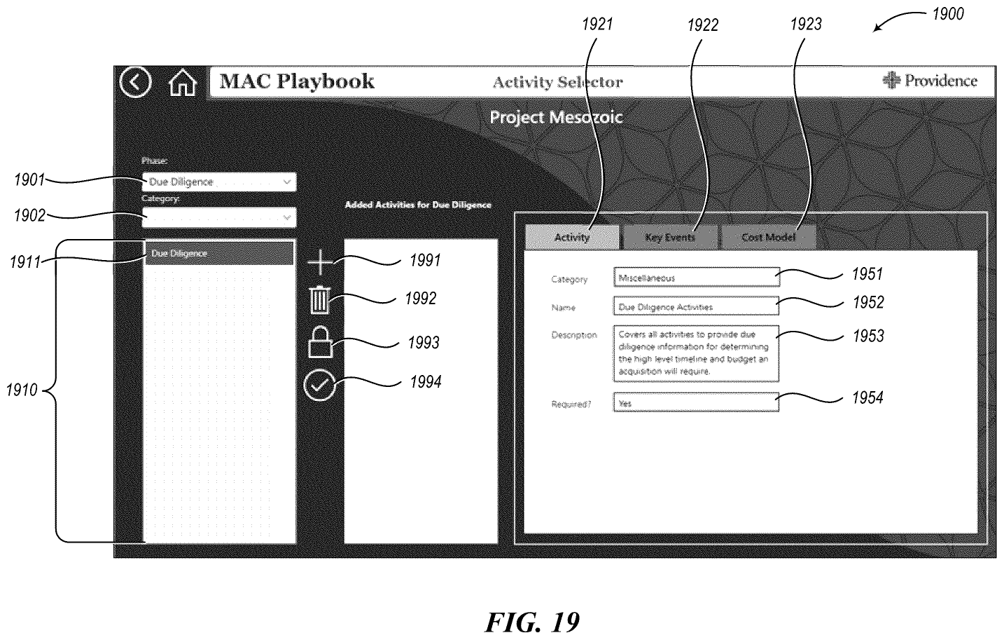

FIG. 19 is a display diagram showing sample contents of a display presented by the facility in some embodiments to continue adding an activity to a project. In some embodiments, the facility presents display 1905 in response to the user's selection of the due diligence phase using control 1801 in display 1800 shown in FIG. 18. In particular, the facility displays a list 1910 of the activities in the facility's activity inventory within the due diligence phase. In this case, the only activity listed is a “due diligence” activity 1911. After selecting due diligence activity 1911, the user activates the add activity icon 1991.

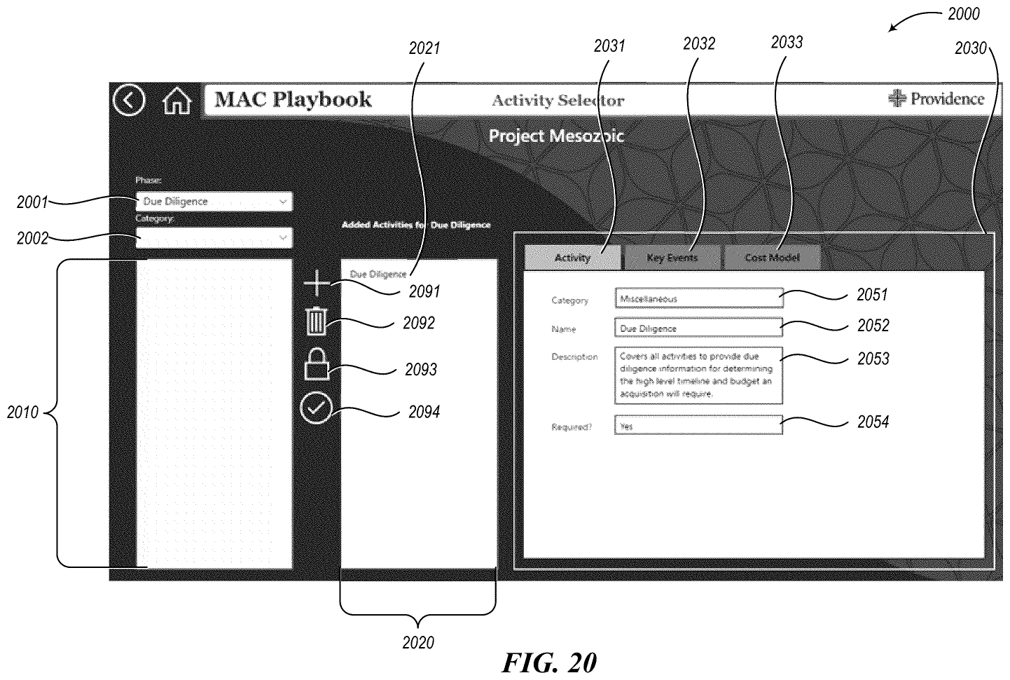

FIG. 20 is a display diagram showing sample contents of a display presented by the facility in some embodiments to continue adding an activity. Display 2000 is presented by the facility in response to the user's selection of the due diligence activity 1911 and the add activity icon 1991 contained in display 1900 shown in FIG. 19. In response, the facility has moved the due diligence activity from the activity inventory 2010 to the activity list 2020 for the due diligence phase of sample project Mesozoic. Information 2030 is describing the due diligence activity instance added to sample project Mesozoic is shown and can be changed. In particular, a view of the due diligence activity instance containing fields 2051-2054 is shown in response to selection of the activity tab 2031; key events tab 2032 and cost model tab 2033 can similarly be selected to display and change this information for the due diligence activity instance. To add an activity in another phase, the user can use phase selector control 2001 to select a different phase, such as final.

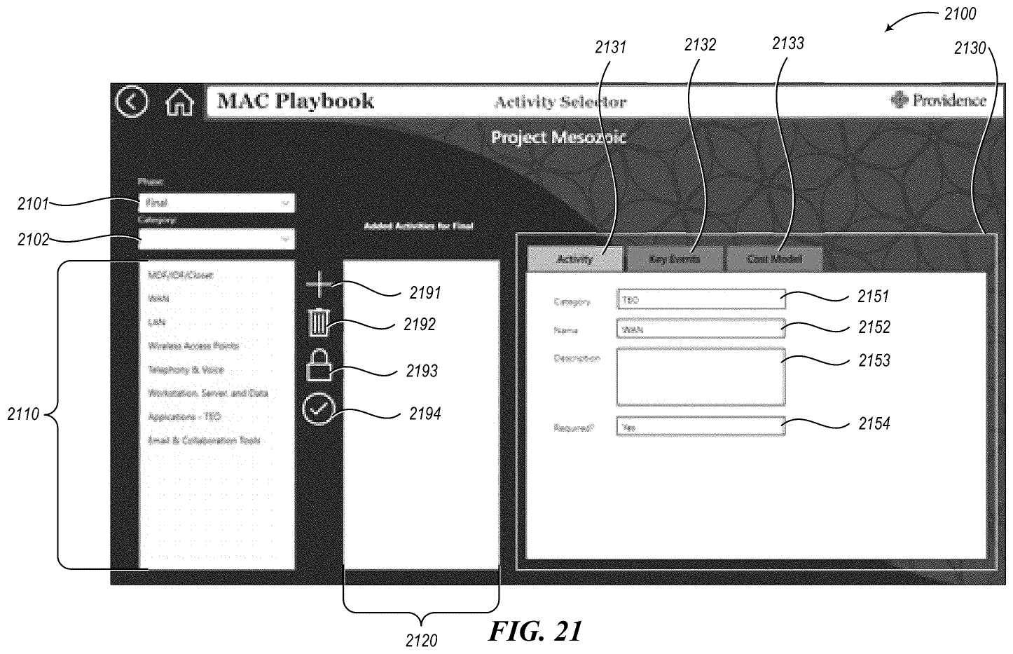

FIG. 21 is a display diagram showing sample contents of a display presented by the facility in some embodiments to continue adding activities to a sample project. In some embodiments, the facility presents display 2100 in response to the user interacting with control 2001 shown in display 2000 of FIG. 20 to select the phase “final” rather than the phase “due diligence.” Display 2100 shows the selection of the final phase in control 2101, as well as a list 2110 of activities in the facility's activity inventory for this phase. In order to include all of the activities in inventory 2110 in sample project Mesozoic, the user activates includes all control 2193.

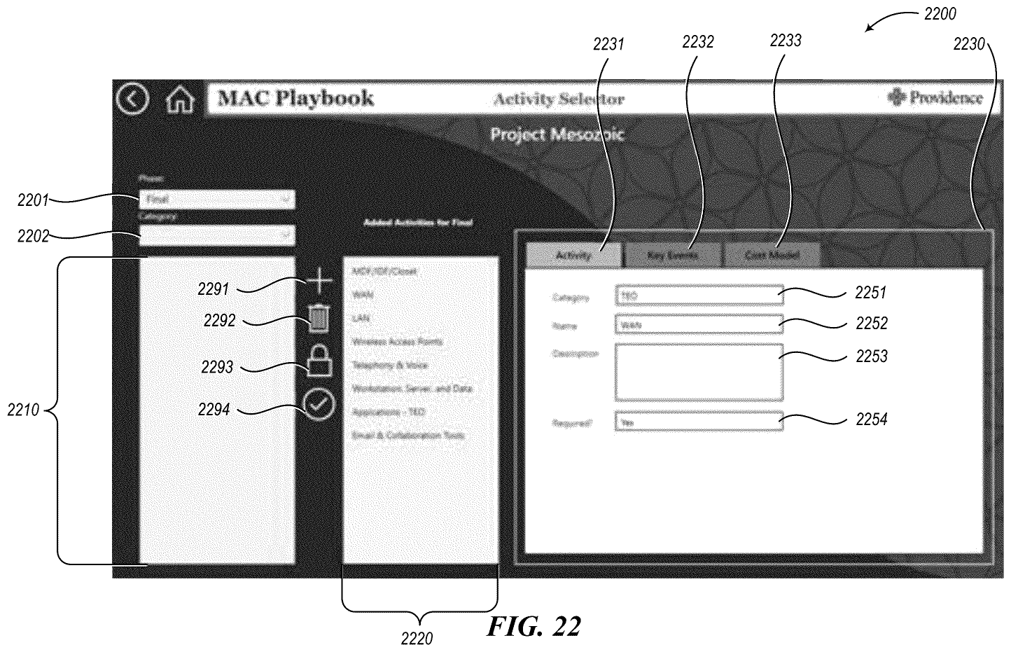

FIG. 22 is a display diagram showing sample contents of a display presented by the facility in some embodiments to continue adding activities to a sample project. In some embodiments, the facility presented display 2200 in response to the user's activation of the include all icon 2193 shown in display 2100 of FIG. 21. It can be seen that, in display 2200, the facility has moved the entire list of activities in the facility's activity inventory 2210 into sample project Mesozoic activity list 2220 for the final phase. The user can modify any of these included activities by selecting it in list 2220, then interacting with subwindow 2230.

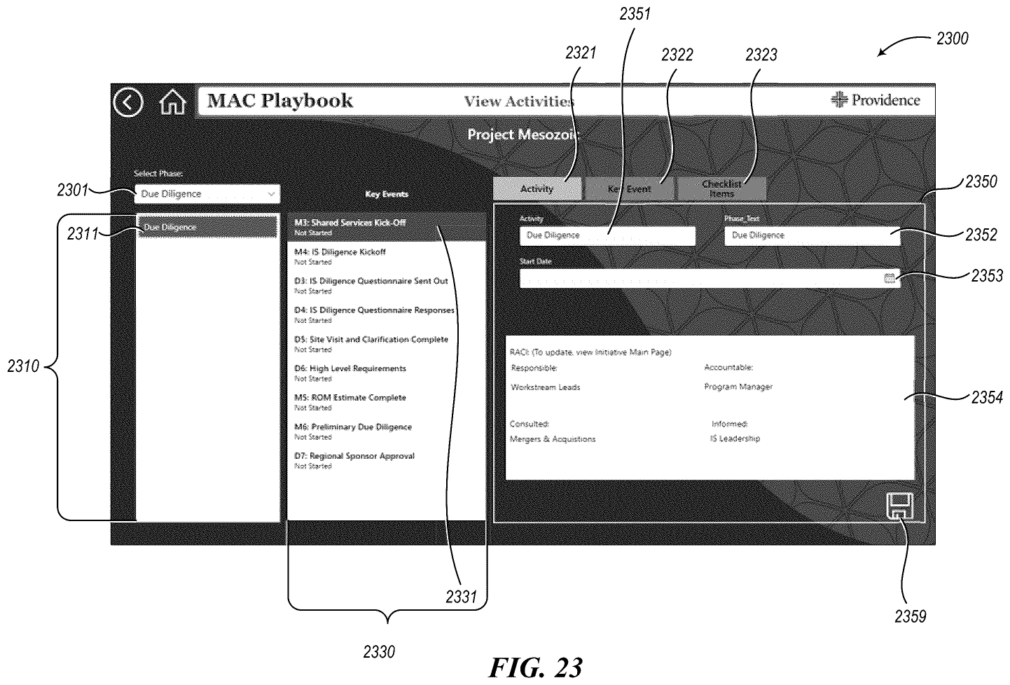

FIG. 23 is a display diagram showing sample contents of a display presented by the facility in some embodiments to update checklist items. In some embodiments, the facility presents display 2300 in response to the user's selection of the calendar icon 1592 shown in display 1500 of FIG. 15. The user uses control 2301 to select the phase of the project to whose activities the user wishes to add dates. In the list 2310 of activities in the selected phase, the user selects activity 2311 to which to add dates. The key events 2334 of this selected activity are shown. It can be seen that, among tabs 2321-2323, the activity tab 2321 is selected. Information pane 2350 for this activity shows the activity's name 2351 and phase 2352, as well as additional activity information 2354. It can also be seen that the start date field 2353 for this activity is empty. The user can enter a date in date field 2353 to establish a start date for this activity.

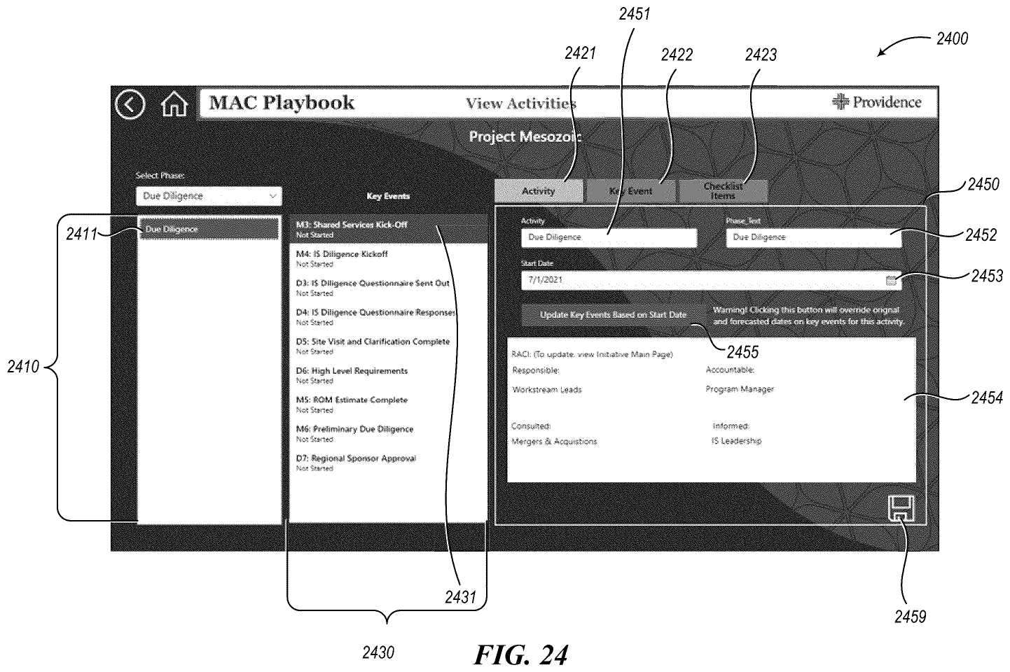

FIG. 24 is a display diagram showing sample contents of a display presented by the facility in some embodiments to continue adding a start date to an activity. By comparing display 2400 to display 2300 shown in FIG. 23, it can be seen that the user entered a start date of Jul. 1, 2021 for the due diligence activity in field 2453. In response, the facility has displayed button 2455, which the user can activate in order to update key events that belong to the selected activity with start dates that are based upon the start date entered for the activity. After activating button 2455, the user can activate save icon 2459 to save the dates added to both the activity and its key events. To display the dates automatically added by the facility to the activity's key events, the user activates the key event tab 2422.

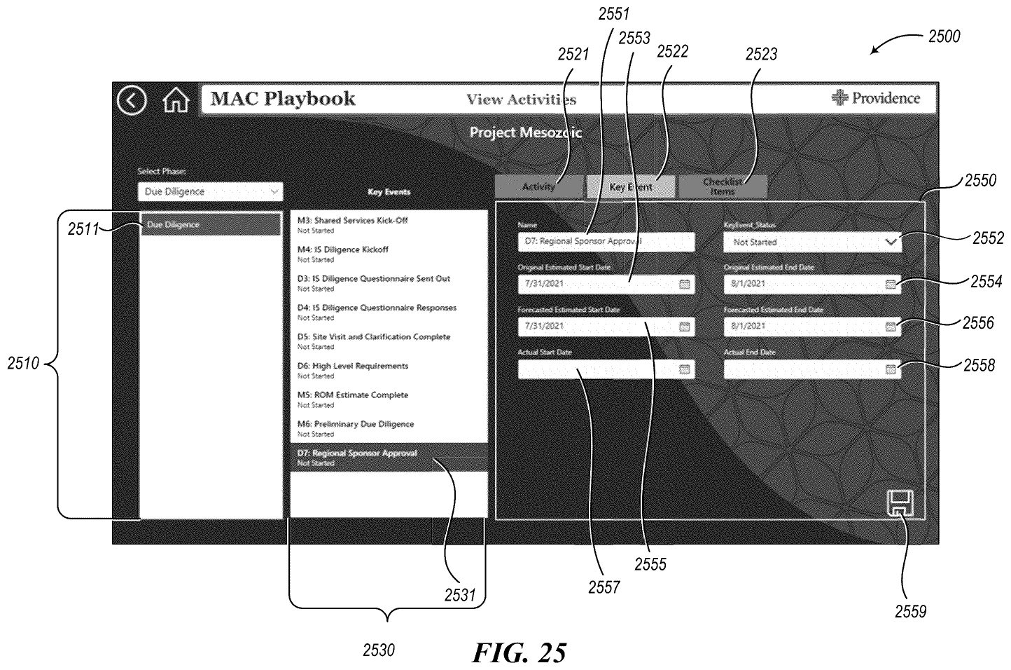

FIG. 25 is a display diagram showing sample contents of a display presented by the facility in some embodiments to display dates automatically added to the selected activity's key events. In display 2500, among tabs 2521-2523, the key event tab 2522 is selected. Furthermore, the user has selected among the list of key events 2630 for the selected due diligence activity 2511 the final key event 2531. In response, the facility has displayed the contents of information pane 2550, relating to the details of the selected key event, including dates automatically determined by the facility for the key event based upon the starting date specified by the user for its activity. In particular, the information pane shows the key event's name 2551; the key event's status 2552; the key event's original estimated start date 2553 of Jul. 31, 2021; the key event's original estimated end date 2554 of Aug. 1, 2021; the key event's forecasted estimated start date 2555 of Jul. 31, 2021; the key event's forecasted estimated end date 2556 of Aug. 1, 2021; empty actual start date 2557; and empty actual start date 2558.

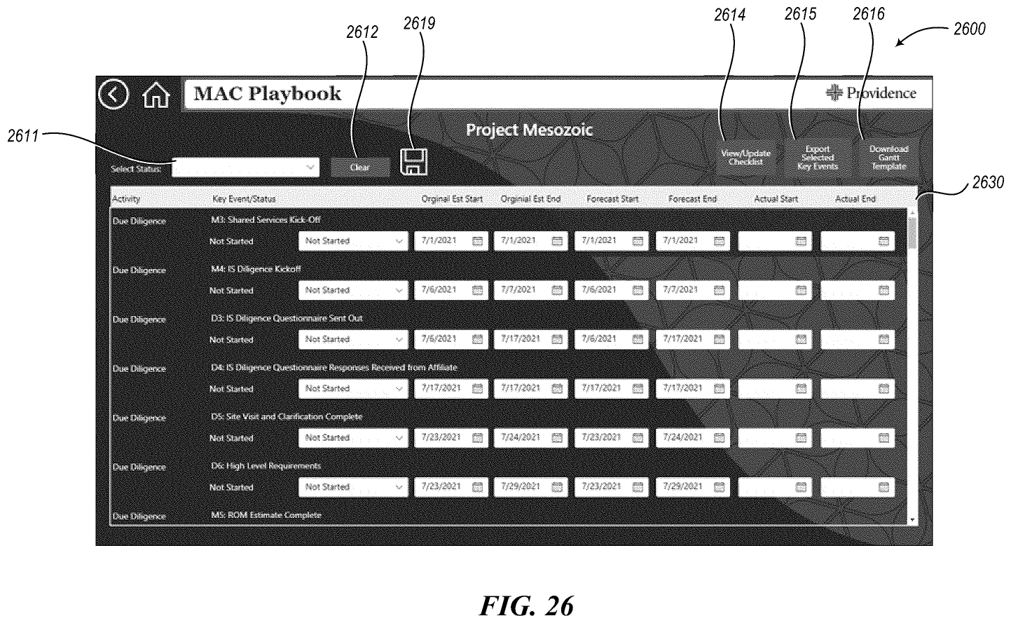

FIG. 26 is a display diagram showing sample contents of a display presented by the facility in some embodiments to present a schedule grid for key events of an initiative. In some embodiments, the facility presents display 2600 in response to the user activating the key events icon 1593 shown in display 1500 of FIG. 15. The display includes grid 2630, in which each row is a different key event for the project, and the columns include the key event's activity; the key event's name and status; the key event's original estimated start date; the key event's original estimated end date; the key event's forecast start date; the key event's forecast end date; the key event's actual start date; and the key event's actual end date. In some embodiments, the user can adjust some or all of this information, and activate the save icon 2619 in order to save these changes, the user can also activate button 2615 in order to export some or all of these key events, such as to a spreadsheet. The user can also activate button 2616 in order to export a template for a Gantt chart including these key events and their dates. Further, the user can activate button 2614 in order to update checklist items for this initiative.

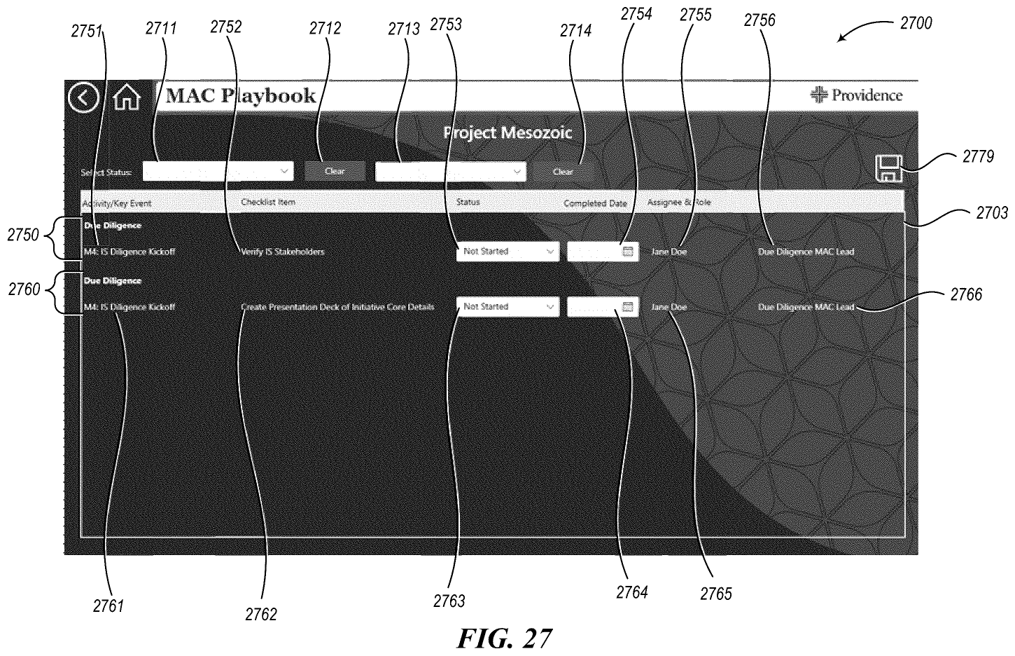

FIG. 27 is a display diagram showing sample contents of a display presented by the facility in some embodiments to view and update checklist items for an initiative. The display shows information 2703 about checklist items that belong to the “M4: IS Diligence Kickoff” key event of the “Due Diligence” activity. Row 2750 relates to the checklist item “Verify IS Stakeholders,” and includes its status 2753, its completed date 2754, its assignee 2755, and her role 2756. Row 2760 similarly relates to the “Create Presentation Deck of Initiative Core Details,” and the same additional information. The user can use controls 2753 and 2763 to change the status of these checklist items, and/or use fields 2754 and 2764 to change the completed dates of these items. After doing so, the user can activate save control 2779 in order to save these changed checklist item details.

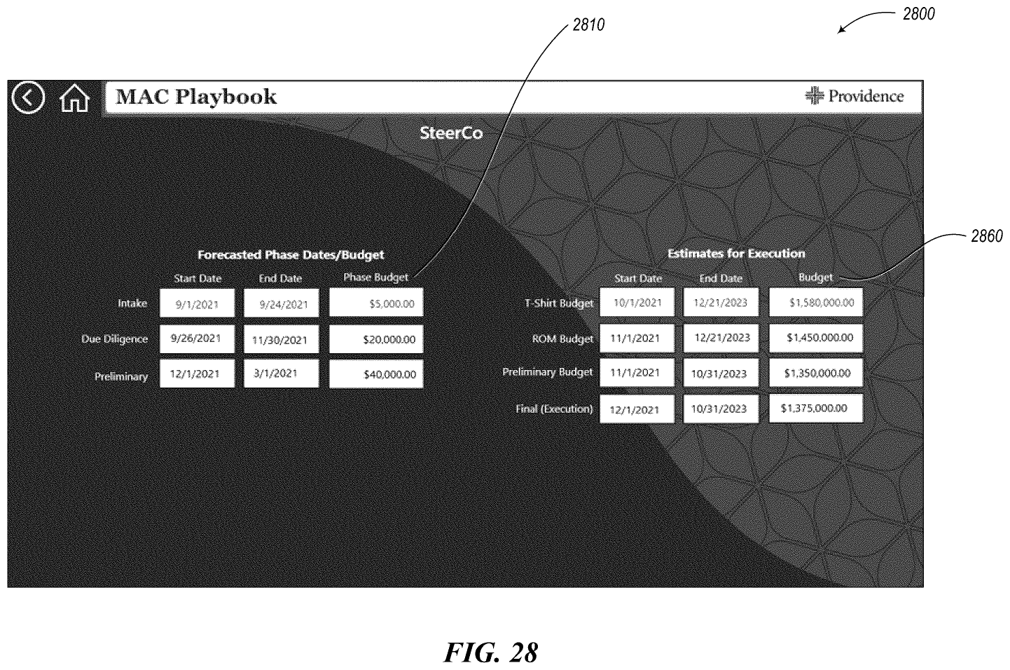

FIG. 28 is a display diagram showing sample contents of a display presented by the facility in some embodiments to estimate schedule and cost information for a project. In some embodiments, the facility presents display 2800 in response to the user activating chart icon 1594. Region 2810 shows forecasted start and end dates and budget for each of three phases of the project, “intake,” “due diligence,” and “preliminary.” Region 2860 shows estimated start and end dates and budget for the project's activities, including “key-shirt budget,” “ROM budget,” “preliminary budget,” and “final (execution).”

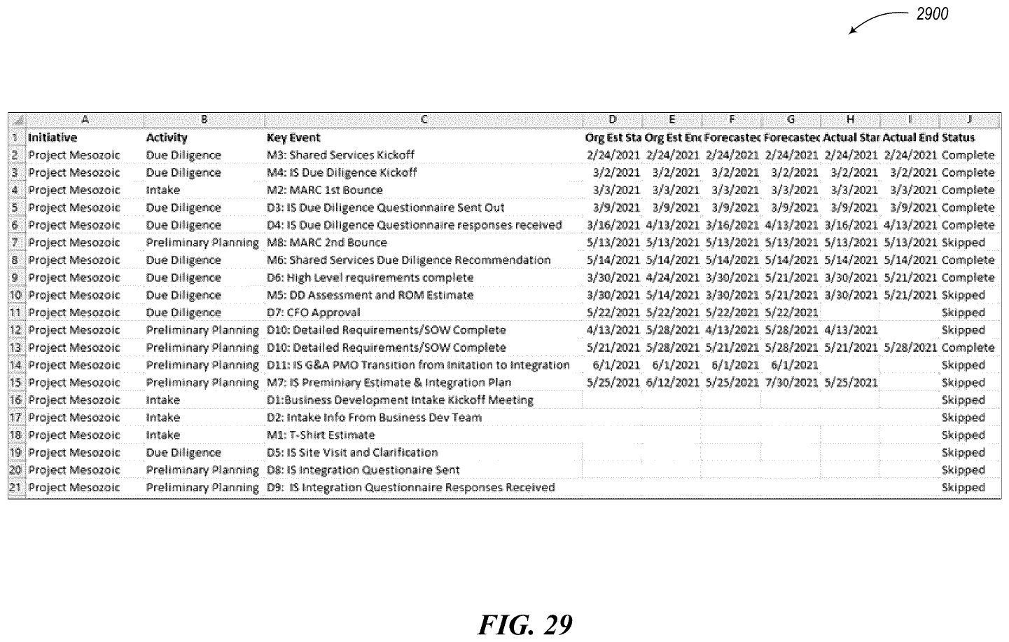

FIG. 29 is a spreadsheet diagram showing sample contents of a spreadsheet exported by the facility in some embodiments to provide information about key events. In some embodiments, the facility generates spreadsheet 2900 in response to the user's activation of button 2615 shown in display 2600 of FIG. 26. After the headings row of the spreadsheet, each row of the spreadsheet corresponds to a different key event of the project. In each row, information can appear in the following columns: initiative name; activity name; key event name; original estimated start date; original estimated end date; forecasted start date; forecasted end date; actual start date; actual end date; and status.

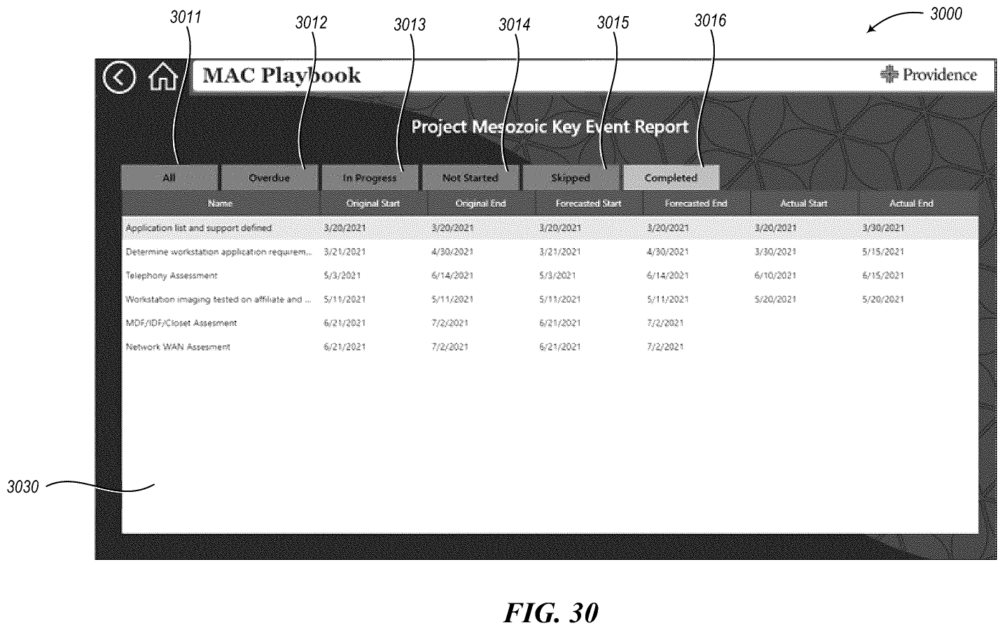

FIG. 30 is a display diagram showing sample contents of a key event report display presented by the facility in some embodiments. The display 3000 includes tabs 3011-3016, each corresponding to a different key event status. The user can select one of the tabs, such as completed tab 3016 selected as shown, to display in the information pane 3030 information about key events having the completed status. For each of the events, the report shows the key event's name, original start date, original end date, forecasted start date, forecasted end date, actual start date, and actual end date.

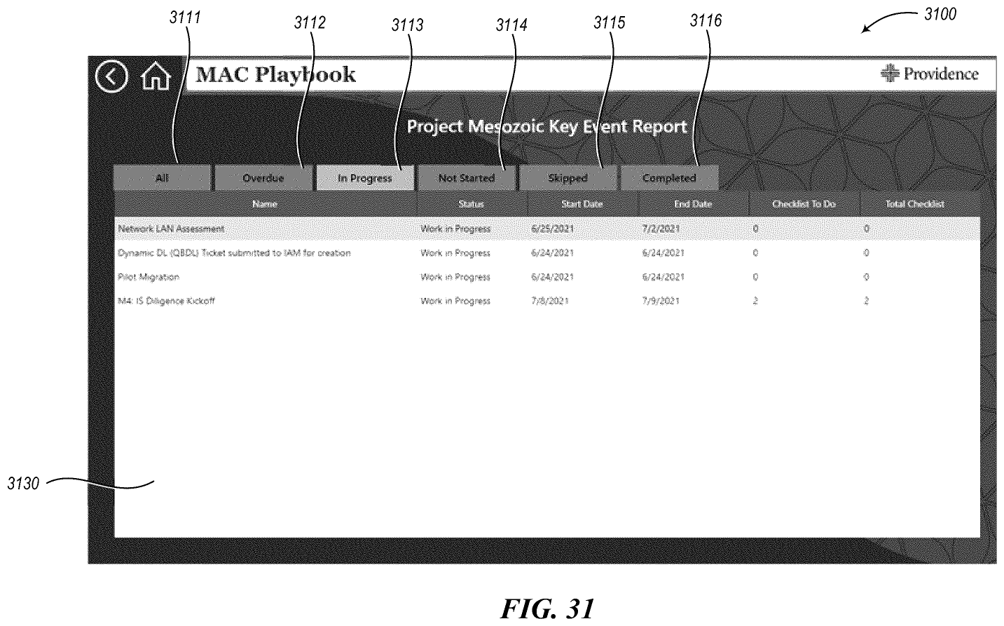

FIG. 31 is a display diagram showing sample contents of the key event report in a second view. By comparing display 3100 to display 3000 shown in FIG. 30, it can be seen that the user has selected in progress tab 3113. In response, the facility has displayed the four key events having this status in information pane 3130.

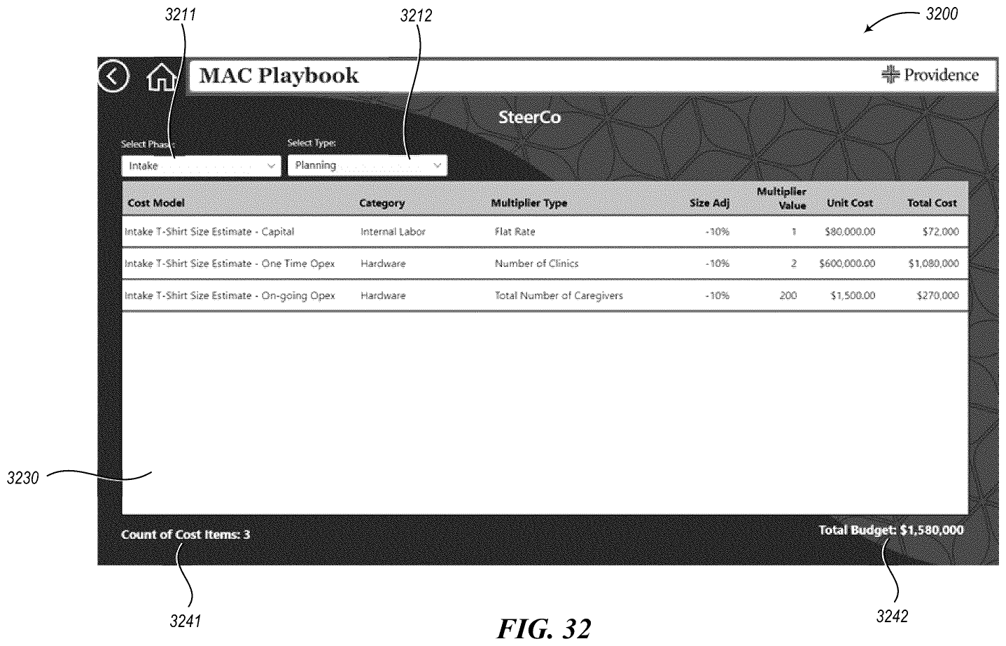

FIG. 32 is a display diagram showing sample contents of a cost model report display presented by the facility in some embodiments. The display 3200 contains control 3211 for specifying a phase of the project, and control 3212 for specifying either planning or actual. It can be seen that the user has selected the intake phase, and the planning report type to show the estimated budget for the initiative in totality. In response, the facility has displayed list 3230 showing three different cost models. For each, the list shows the cost model's name; category; multiplier type; size adjustment; multiplier value; unit cost; and total cost. The first cost model is a flat rate cost of $80,000 that has been adjusted by a size adjustment of negative 10% to arrive at a total cost of $72,000. The second cost model is a $600,000 unit cost that is multiplied by two clinics, then subjected to a negative 10% size adjustment to arrive at a total cost of $1,080,000. The third cost model is a unit cost of $1,500, multiplied by a total number of caregivers of 200, then subjected to a negative 10% size adjustment, to arrive at a total cost of $270,000. The display also includes a count 3241 of the three cost items, as well as a total budget 3242 summing the total costs of the three shown cost models. The user can interact with the control 3212 to change the report from planning to actual.

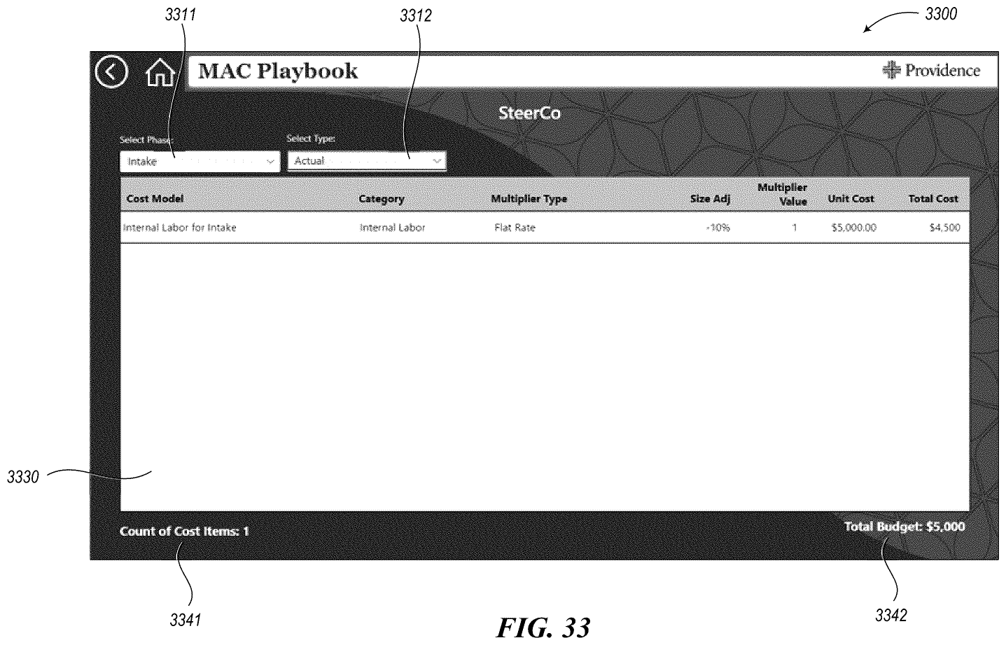

FIG. 33 is a display diagram showing sample contents of the cost model report presented by the facility in some embodiments in a second state. In some embodiments, the facility presents display 3300 in response to the user using control 3312 to select the actual report type. In response, the facility displays a single flat rate cost model in information pane 3330.

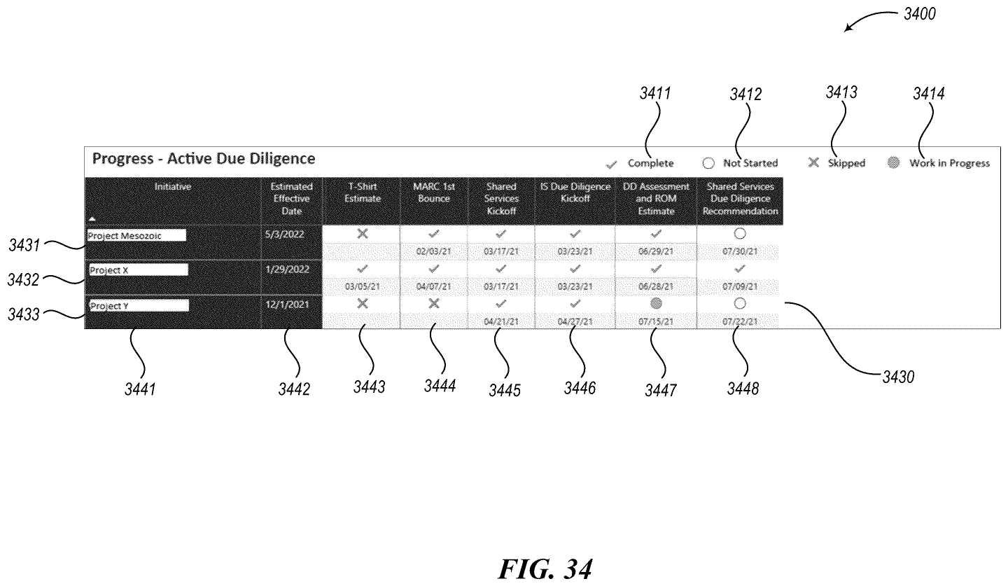

FIG. 34 is a display diagram showing sample contents of a display presented by the facility in some embodiments to provide project analytics. The display 3400 includes a table 3430 made up of rows 3431-3433, each corresponding to a different initiative. Each row contains the initiative's name 3441, estimated effective date 3442, and status and completion dates for the following key events: t-shirt estimate 3443, MARC 1st bounce 3444, shared services kickoff 3445, IS due diligence kickoff 3446, DD assessment and ROM estimate 3447, and shared services due diligence recommendation 3548. In particular, the status of each key event for each initiative is shown using status symbols 3411-3414.

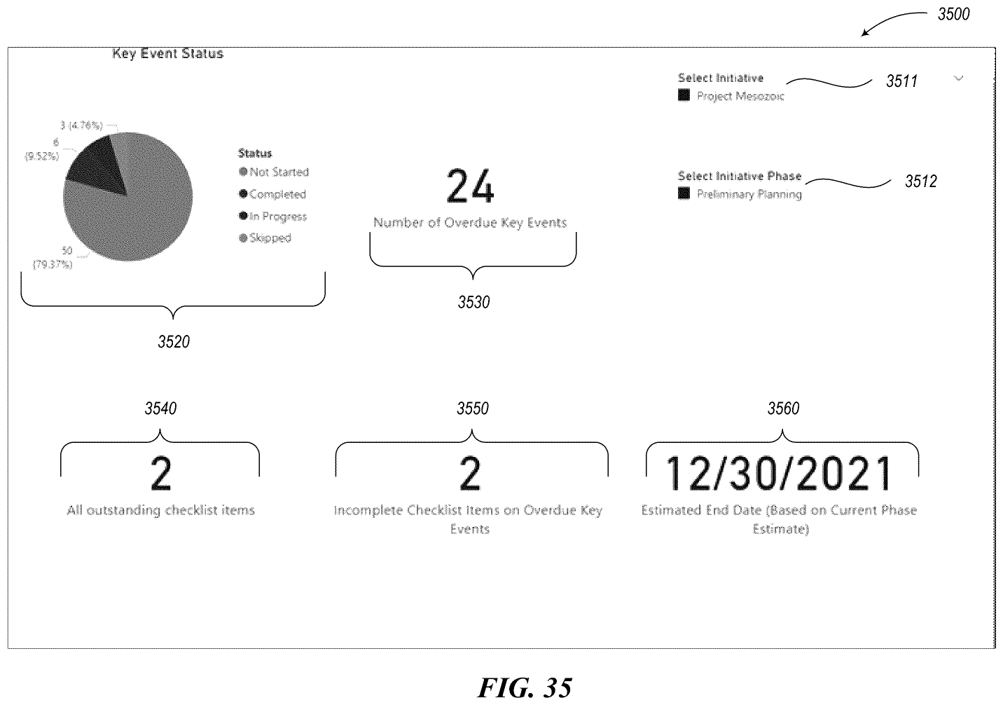

FIG. 35 is a display diagram showing sample contents of a project status dashboard presented by the facility in some embodiments. The display 3500 includes a control 3511 for selecting a particular initiative, and control 3512 for selecting a phase of that initiative for which to provide information. The display further includes a pie graph 3520 of the number of key events having each key event status, as well as a count 3530 of the number of key events that are overdue. The display further includes a count 3540 of the number of outstanding checklist items, and a count 3550 of the incomplete checklist items that belong to key events that are overdue. Finally, the display includes an estimated end date 3560 that is based on the current phase estimate.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system for constructing a plan for a project, comprising:
initializing a stored state representing the project;
soliciting and receiving user input specifying at least one phase of the project;
updating the stored state to reflect the specified at least one phase;
for a distinguished specified phase, soliciting and receiving user input specifying at least one activity of the distinguished phase;
updating the stored state to reflect the specified at least one activity;
for a distinguished specified activity, soliciting and receiving user input specifying at least one key event of the distinguished activity;
updating the stored state to reflect the specified at least one key event;
for a distinguished specified key event, soliciting and receiving user input specifying at least one checklist item of the distinguished key event; and
updating the stored state to reflect the specified at least one checklist item.

2. The method of claim 1 wherein the project is an information technology project to be performed with respect to a group of users,
and wherein at least one of the specified activities is to establish an electronic resource usable by the users of the group.

3. The method of claim 1 wherein the distinguished phase, activity, key event, and checklist item comprise a hierarchy for the project,
the method further comprising:
receiving user input specifying a navigation path through hierarchy; and
in response to receiving the user input specifying a navigation path, causing to be displayed information about the project contained in the stored state in accordance with the specified navigation path.

4. The method of claim 3 wherein the specified navigation path is comprised of steps,
and where the causing to be displayed is performed in response to receiving the user input corresponding to each step.

5. The method of claim 1, further comprising:
for a distinguished specified checklist item, soliciting and receiving user input specifying at least one attribute of the distinguished checklist item;
updating the stored state to reflect the specified at least one attribute of the distinguished checklist item;
using the specified at least one attribute of the distinguished checklist item to determine one or both of a cost and a time period for the distinguished checklist item;
updating the stored state to reflect the one or both of a cost and a time period determined for the distinguished checklist item;
using the specified at least one attribute of the distinguished checklist item to determine one or both of a cost and a time period for the distinguished key event;
updating the stored state to reflect the one or both of a cost and a time period determined for the distinguished key event;
using the specified at least one attribute of the distinguished checklist item to determine one or both of a cost and a time period for the distinguished activity;
updating the stored state to reflect the one or both of a cost and a time period determined for the distinguished activity;
using the specified at least one attribute of the distinguished checklist item to determine one or both of a cost and a time period for the distinguished phase; and
updating the stored state to reflect the one or both of a cost and a time period determined for the distinguished phase.

6. The method of claim 1, further comprising:
soliciting and receiving user input specifying at least one attribute of the distinguished key event;
updating the stored state to reflect the specified at least one attribute of the distinguished key event;
using the specified at least one attribute of the distinguished key event to determine one or both of a cost and a time period for the distinguished key event;
updating the stored state to reflect the one or both of a cost and a time period determined for the distinguished key event;
using the specified at least one attribute of the distinguished key event to determine one or both of a cost and a time period for the distinguished activity;
updating the stored state to reflect the one or both of a cost and a time period determined for the distinguished activity;
using the specified at least one attribute of the distinguished key event to determine one or both of a cost and a time period for the distinguished phase; and
updating the stored state to reflect the one or both of a cost and a time period determined for the distinguished phase.

7. The method of claim 1, further comprising:
soliciting and receiving user input specifying at least one attribute of the distinguished activity;
updating the stored state to reflect the specified at least one attribute of the distinguished activity;
using the specified at least one attribute of the distinguished activity to determine one or both of a cost and a time period for the distinguished activity;
updating the stored state to reflect the one or both of a cost and a time period determined for the distinguished activity;
using the specified at least one attribute of the distinguished activity to determine one or both of a cost and a time period for the distinguished phase; and
updating the stored state to reflect the one or both of a cost and a time period determined for the distinguished phase.

8. The method of claim 1, further comprising:
soliciting and receiving user input specifying at least one attribute of the distinguished phase;
updating the stored state to reflect the specified at least one attribute of the distinguished phase;
using the specified at least one attribute of the distinguished phase to determine one or both of a cost and a time period for the distinguished phase; and
updating the stored state to reflect the one or both of a cost and a time period determined for the distinguished phase.

9. The method of claim 1, further comprising:
soliciting and receiving user input specifying at least one attribute of the project; project;
using the specified at least one attribute of the distinguished phase to determine one or both of a cost and a time period for one or more of the distinguished phase, the distinguished activity, the distinguished key event, or a distinguished specified checklist item; and
updating the stored state to reflect the one or both of a cost and a time period determined for the one or more of the distinguished phase, the distinguished activity, the distinguished key event, or the distinguished checklist item.

10. The method of claim 9 wherein the project is a project to be performed with respect to a group of people,
and wherein the specified at least one attribute of the project comprises the number of people in the group of people.

11. The method of claim 1, further comprising:
receiving user input specifying an actual completion date for the distinguished checklist item;
in response to receiving the user input specifying an actual completion date for the distinguished checklist item:
determining, storing, and causing to be displayed a projected completion date for the distinguished key event that is based on the specified actual completion date;
determining, storing, and causing to be displayed a projected completion date for the distinguished activity that is based on the specified actual completion date; and
determining, storing, and causing to be displayed a projected completion date for the distinguished phase that is based on the specified actual completion date.

12. The method of claim 1, further comprising:
receiving user input specifying an actual completion date for the distinguished key event;
in response to receiving the user input specifying an actual completion date for the distinguished key event:
determining, storing, and causing to be displayed a projected completion date for the distinguished activity that is based on the specified actual completion date; and
determining, storing, and causing to be displayed a projected completion date for the distinguished phase that is based on the specified actual completion date.

13. The method of claim 1, further comprising:
receiving user input specifying an actual completion date for the distinguished activity;
in response to receiving the user input specifying an actual completion date for the distinguished activity:
determining, storing, and causing to be displayed a projected completion date for the distinguished phase that is based on the specified actual completion date.

14. One or more instances of computer-readable media collectively having contents configured to cause a computing system to perform a method with respect to a planned project, the method comprising:
initializing a project-tracking data object;
responding to user input by assembling in the data object a hierarchical model of the project, from project elements each having one of a plurality of element types; and
persistently storing the data object containing the assembled model.

15. The one or more instances of computer-readable media of claim 14 wherein the plurality of element types comprise project, project phase, project activity, project key event, and project checklist item.

16. The one or more instances of computer-readable media of claim 15, the method further comprising:
for each at least a portion of the project elements from which the hierarchical model of the project is assembled:
receiving user input specifying one or more attributes of the project element; and
storing the specified attributes for the project element in the data object.

17. The one or more instances of computer-readable media of claim 14 wherein a definition for a distinguished one of the project elements incorporated in the hierarchical model of the project has a definition that specifies a formula for calculating a cost of the project element,
the method further comprising:
applying the formula to a distinguished project element attribute specified by user input to determine a cost for the distinguished project element.

18. The one or more instances of computer-readable media of claim 14 wherein a definition for a distinguished one of the project elements incorporated in the hierarchical model of the project has a definition that specifies a formula for predicting a completion date of the project element,
the method further comprising:
applying the formula to a distinguished project element attribute specified by user input to predict a completion date for the distinguished project element.

19. The one or more instances of computer-readable media of claim 14, the method further comprising:
receiving user input specifying an actual completion date for a distinguished one of the project elements incorporated in the hierarchical model of the project;
in response to receiving the user input specifying an actual completion date for the distinguished project element:
determining, storing, and displaying a projected completion date that is based on the specified actual completion date for one or more project elements that are ancestors of the distinguished project element in the hierarchical model of the project.

20. The one or more instances of computer-readable media of claim 14, the method further comprising:
receiving user input specifying a navigation path through hierarchical model of the project; and
in response to receiving the user input specifying a navigation path, causing to be displayed information about the project contained in the stored data object in accordance with the specified navigation path.

21. The one or more instances of computer-readable media of claim 20 wherein the specified navigation path is comprised of steps,
and where the causing to be displayed is performed in response to receiving the user input corresponding to each step.

22. The one or more instances of computer-readable media of claim 14, the method further comprising:
generating and causing to be displayed an analytics report based on data contained by the data object.

23. A method in a computing system, comprising:
initializing an inventory of project elements;
for each of a plurality of project element types:
for each of one or more project elements of the project element type:
receiving user input naming the project element;
receiving user input specifying an attribute of the project element; and
adding to the inventory of project elements a project element reflecting the received user input; and
for each of a plurality of projects:
receiving user input specifying a name for the project;
creating to a project model data store a model for the project comprising the specified project name; and
for each of a plurality of the project elements among the inventory of project elements:
receiving user input selecting the project element for the project; and
receiving user input specifying a value for the attribute specified for the project element; and
adding to the created project model an instance of the selected project element and the specified attribute value.

24. The method of claim 23 wherein the plurality of project element types comprise project phase, project activity, project key event, and project checklist item.

25. The method of claim 23, further comprising:
for a distinguished one of the plurality of projects:
receiving using input specifying a project attribute value; and
storing the specified project attribute value in the project model created for the project.

26. The method of claim 25, further comprising:
on the basis of the specified project attribute value, recommending a proper subset of the project elements among the inventory of project elements for inclusion in the project.

27. The method of claim 25 wherein the user input specifying an attribute of a distinguished project element (1) specifies that the attribute is a cost estimate for the distinguished project element, and (2) specifies a formula for calculating a value for cost estimate attribute that is based on the project attribute for which a value specified for the distinguished project,
the method further comprising applying the specified formula to the project attribute value specified for the distinguished project to obtain a cost estimate for the distinguished project element in the distinguished project.

28. The method of claim 25 wherein the user input specifying an attribute of a distinguished project element (1) specifies that the attribute is a time estimate for the distinguished project element, and (2) specifies a formula for calculating a value for time estimate attribute that is based on the project attribute for which a value specified for the distinguished project,
the method further comprising applying the specified formula to the project attribute value specified for the distinguished project to obtain a time estimate for the distinguished project element in the distinguished project.
